(19) United States
(12) Patent Application Publication
(10) Pub. No.: US 2026/0236034 A1
(43) Pub. Date: Aug. 13, 2026

(54) DETERMINATION OF PATH WITH ENHANCED OR OPTIMIZED COLLECTION AND TIME IN DYNAMIC ENVIRONMENTS

(71) Applicant: Massachusetts Institute of Technology, Cambridge, MA (US)

(72) Inventors: Pierre Lermusiaux, Cambridge, MA (US); Manmeet Singh Bhabra, St. Louis, MO (US); Manan Doshi, Cambridge, MA (US)

(73) Assignee: Massachusetts Institute of Technology, Cambridge, MA (US)

(21) Appl. No.: 19/156,119

(22) PCT Filed: Dec. 14, 2023
(86) PCT No.: PCT/US2023/084021

§ 371 Date: Aug. 13, 2025

Related U.S. Application Data
(60) Provisional application No. 63/485,179, filed on Feb. 15, 2023.

(51) Int. Cl. G05D 1/644; G05D 109/30

(52) U.S. Cl. CPC G05D 1/644; G05D 2109/30

(57) ABSTRACT

Techniques for use in connection with determining a collection, time, and usage optimized route for a vehicle may include obtaining collection, usage, and time optimized reachable sets, obtaining a Pareto front of Pareto solutions for optimum time and optimum collectible, reachable at a target final location and target collectible level, and using the Pareto solutions to provide an optimized route for the vehicle. The vehicle may be guided using the optimized route and may collect an enhanced quantity of a collectible along the optimized route.

### RELATED APPLICATIONS

This application claims the benefit under 35 U.S.C. § 119(e) of U.S. Provisional Application Ser. No. 63/485,179, filed Feb. 15, 2023, and tided, “DETERMINATION OF PATH WITH ENHANCED OR OPTIMIZED COLLECTION AND TIME IN DYNAMIC ENVIRONMENTS,” which is hereby incorporated herein by reference in its entirety.

### GOVERNMENT SPONSORSHIP

This invention was made with government support under N00014-14-1-0476 awarded by the Office of Naval Research. The government has certain rights in the invention.

### FIELD OF INVENTION

The techniques described herein relate to the field of vehicle routes in dynamic environments.

### BACKGROUND

A vehicle in a dynamic environment may travel along a route. The vehicle may use a particular amount of energy to travel along the route, may take a particular amount of time to travel along the route, and may collect a particular amount of a collectible along the route.

### SUMMARY

According to aspects of the disclosure there is provided, a method for use in automatically determining optimized routes for vehicles. The method comprises using at least one computer hardware processor to perform providing at least an initial location and at least a target final location of a vehicle, in physical space, obtaining dynamic environmental flow field information and dynamic collectible field information, determining, using the dynamic environmental flow field information and the dynamic collectible field information, at least one optimized route from the initial location to the target final location, comprising obtaining collection, usage, and time optimized reachable sets or tubes, obtaining a Pareto front of Pareto solutions for optimum time and optimum collectible, reachable at the target final location, and using the Pareto solutions to provide an optimized route for the vehicle, guiding the vehicle using the optimized route, and collecting an enhanced quantity of the collectible along the optimized route.

According to aspects of the disclosure there is provided at least one non-transitory computer-readable storage medium storing processor executable instructions that, when executed by at least one computer hardware processor, cause the at least one computer hardware processor to perform a method for use in automatically determining optimized routes for vehicles. The method comprises using at least one computer hardware processor to perform providing an initial location and a target final location of a vehicle, in physical space, obtaining dynamic environmental flow field information and dynamic collectible field information, determining, using the dynamic environmental flow field information and the dynamic collectible field information, at least one optimized route from the initial location to the target final location, comprising obtaining collection, usage, and time optimized reachable sets, obtaining a Pareto front of Pareto solutions for optimum time and optimum collectible, reachable at the target final location, and using the Pareto solutions to provide an optimized route for the vehicle, guiding the vehicle using the optimized route, and collecting an enhanced quantity of the collectible along the optimized route.

According to aspects of the disclosure there is provided a system. The system comprises at least one computer hardware processor, at least one non-transitory computer-readable storage medium storing processor executable instructions that, when executed by the at least one computer hardware processor, cause the at least one computer hardware processor to perform a method for use in automatically determining an optimized route for a vehicle, the method comprising using at least one computer hardware processor to perform obtaining a target state, a fixed initial position of the vehicle, uncertain dynamic environmental flow information, and uncertain dynamic collectible field information and determining an optimized route from the fixed initial position to the target state using the uncertain dynamic environmental flow information and the uncertain dynamic collectible field information, wherein the determining includes solving for stochastic collectible and time optimum paths and/or probabilistic reachability sets in a dynamically uncertain environment using dynamic stochastic order reduction including using a dynamically orthogonal (DO) decomposition of a stochastic time-optimal level set or value function to efficiently solve corresponding stochastic DO level-set equations, and a device that guides the vehicle using the optimized route.

The foregoing is a non-limiting summary of the invention, which is defined by the attached claims.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Various aspects and embodiments of the disclosure provided herein are described below with reference to the following figures. It should be appreciated that the figures are not necessarily drawn to scale. Items appearing in multiple figures are indicated by the same or a similar reference number in all the figures in which they appear.

FIG. 1-1 is a block diagram of a route determination system, according to some embodiments;

FIG. 1-2 is a block diagram of a computer system, according to some embodiments;

FIG. 2-1 is a flowchart of one method related to determining optimized routes for vehicles, according to some embodiments;

FIG. 2-2 is a flowchart of another method related to determining optimized routes for vehicles, according to some embodiments;

FIG. 3 is a schematic of an environment for determining optimized routes for vehicles, according to some embodiments;

FIG. 4 is another schematic of an environment for determining optimized routes for vehicles, according to some embodiments;

FIG. 5 is a yet another schematic of an environment for determining optimized routes for vehicles, according to some embodiments;

FIG. 6 is a schematic of a Pareto front, according to some embodiments;

FIG. 7 is a schematic of another Pareto front, according to some embodiments,

FIGS. 8-1 and 8-2 are schematics of reachable states, according to some embodiments;

FIG. 9 shows a collectible field, according to a first example;

FIGS. 10A-1 through 10A-6 show a perspective view of and FIGS. 10B-1 through 10B-6 show a top-down view of reachability front evolution, according to the first example;

FIG. 11 shows Pareto fronts, according to the first example;

FIGS. 12-1 through 12-6 show a top-down view of backtracking an optimal path, according to the first example;

FIG. 13 shows optimal paths, according to the first example;

FIGS. 14-1 through 14-3 show a dynamic flow field, according to a second example;

FIG. 15 shows an energy field, according to the second example;

FIGS. 16A-1 through 16A-6 show a perspective view of and FIGS. 16B-1 through 16B-6 show a top-down view of reachability front evolution, according to the second example;

FIGS. 17-1 through 17-12 show a top-down view of reachability front evolution with energy state, according to the second example;

FIG. 18 shows a Pareto front, according to the second example;

FIG. 19 shows a top-down view of optimal paths, according to the second example;

FIGS. 20-1 and 20-2 show optimal speed and optimal energy path evolution, according to the second example;

FIGS. 21-1 through 21-4 show a dynamic flow field, according to a third example;

FIG. 22 show an input field, according to the third example;

FIGS. 23A-1 through 23A-9 show a perspective view of and FIGS. 23B-1 through 23B-9 show a top-down view of reachability front evolution, according to the third example;

FIGS. 24-1 through 24-3 show a top-down view of a backtracked energy, constrained time optimal solution, according to the third example;

FIG. 25 shows required energy at target, according to the third example;

FIGS. 26A-1 through 26A-4 show a perspective view of and FIGS. 26B-1 through 26B-7 show a top-down view of reachability front evolution, according to a fourth example;

FIG. 27 shows a top-down view of an optimal path, according to the fourth example;

FIGS. 28-1 and 28-2 show optimal speed and vehicle energy, according to the fourth example;

FIG. 29 shows a dynamic flow field, according to a fifth example;

FIG. 30 shows evolution of the reachability front, according to the fifth example;

FIG. 31 shows backtracking to compute an optimal path, according to the fifth example;

FIG. 32 shows a collection field, according to a sixth example:

FIG. 33 shows a top-down view of reachability front evolution, according to the sixth example;

FIG. 34-1 shows a top-down view of an optimal path, according to the sixth example; and

FIG. 34-2 shows an amount of a collectible along an optimal path, according to the sixth example.

### DETAILED DESCRIPTION

According to aspects of the disclosure, a path with enhanced or optimal collection and time may be determined. The path may be in dynamic and/or uncertain environments and collectible fields. The path may be determined and used to plan or steer a path of a vehicle.

According to aspects of the disclosure, there are provided methods for use in automatically determining optimized routes for vehicles. For example, a method may comprise obtaining a target state, a fixed initial position of the vehicle, dynamic environmental flow information, and dynamic collectible field information and determining an optimized route from the fixed initial position to the target state using the dynamic environmental flow information and the dynamic collectible fields information. The determining may include solving for joint collection-time optimum paths and/or reachability sets in dynamic collectible fields and physical environment. For uncertain information inputs (e.g., uncertain environmental flow, collectible field, and vehicle properties) dynamic stochastic order reduction is used including a dynamically orthogonal (DO) decomposition of the stochastic collectible- and time-optimal level set or value function to efficiently solve corresponding stochastic DO level-set equations. The vehicle may then be guided using the optimized route.

For example, such a vehicle may comprise a sea surface craft, such as a kayak, sailboat, vessel, ship, or tanker. The vehicle may comprise an autonomous vehicle, such as a propelled autonomous underwater vehicle (AUV), ocean glider or Slocum glider, solar vehicle, wave-powered glider, float, autonomous kayak, unmanned aerial vehicle, autonomous buoy, delivery drone, or sail drones.

According to aspects of the disclosure, a vehicle may perform enhanced or optimal collection and usage of dynamic fields in dynamic environments. Dynamic fields may comprise energy source fields, waste, or pollution fields (such as those to be cleaned up, for example, ocean cleanup of marine plastic pollution, oils spills, sargassum, or other pollution), food and culture fields (such as those to be harvested or sequestered, for example, aquaculture, algae, or other culture).

Harvesting external dynamic fields has numerous applications. For example, for energy, where endurance and low power of a vehicle may be important features, the enhanced or optimal harvest of energy along a path, and/or the vehicle using the environment to reduce energy consumption may be important considerations.

In some embodiments, paths may be determined in water environments, such as ocean or lake applications. In other embodiments, aspects of the disclosure may be applied to other environments, such as in the air (for example, for drones, aircraft, or other vehicles) or on land or in space by small satellites, or in all of these environments at once.

According to aspects of the disclosure, there is provided a theory that governs and a methodology that solves collection and time optimal path planning for autonomous or other vehicles navigating in dynamic environments. In some embodiments, the theory may comprise new exact differential-equations that govern the optimal collection and usage of multiple fields in reduced or minimum time. For example, new differential equations and methodology may solve the multi-objective optimization problem of navigating a vehicle autonomously in a dynamic environmental flow field to any target destination set with the goal of maximizing the collection and usage of multiple specific fields while jointly minimizing travel time. The equations may further govern multiple start and terminal times, all at once.

According to various aspects of the disclosure, collectible fields, the fields to-be-collected by the vehicle along its path, can consist of one or more of energy fields, waste or pollution fields, food or culture fields, or any other fields of material quantities transported by the dynamic environmental flows. For example, energy fields may comprise solar, wind, wave, biological, thermal, or other fields and may be used to increase or maximize energy harvest and/or reduce or minimize energy usage. Waste or pollution fields may comprise marine plastic and litter, oil spills, sargassum, natural and man-made plumes, air particles, or other fields, and may be used for enhanced or optimal cleanup. Food or culture fields may comprise algae, seaweed, aquaculture, travelling farms, or other fields, and may be used for optimal harvesting or growth, such as carbon sequestration etc. In general, collectible fields may comprise any fields of material quantities that are transported or affected by the dynamic environmental flows.

According to aspects of the disclosure, a methodology may be used to predict an augmented collection-usage-time reachable set (and tubes) and reachability front for multiple start/terminal times. The methodology may further be used to predict a collection-usage-time Pareto optimal front. The methodology may also be used to predict optimal paths and controls (such as headings, speeds, and energy usage) for autonomous or other vehicles navigating in dynamic environments while enhancing or optimizing their collection and usage of multiple fields and travel time.

According to one exemplary embodiment of the method, first, there may be a step of selecting at least one initial location and at least one target final destination location of at least one vehicle, in three-dimensional physical space of the environment in which the path may be determined. Second, there may be a step of using information on future dynamic environmental flow fields and dynamic fields to-be-collected or to-be-used (for example, energy fields, waste/pollution fields, food or culture fields, or other fields) to determine, based on these fields, the collection-usage-time optimized reachable sets or tubes, and the corresponding at least one optimal route from the initial to the final sets of locations. Third, there may be a step of numerically integrating the multi-dimensional differential equations governing the augmented reachable set and tubes and reachability front for multi-objective collection-usage-time optimal path planning in dynamic environments and obtaining the collection-usage-time Pareto front and Pareto optimal solutions by direct optimization on the reachable front projected on the physical at least one destination location. Fourth, there may be a step of numerical integrating, for specific Pareto optimal solutions, the augmented trajectory differential equation system backward in time, to provide the optimal physical paths and optimal controls, specifically the time history of at least one optimal heading and at least one optimal speed of the at least one vehicle. Such a method may be performed using at least one computer hardware processor.

The disclosure provides novel equations and methodologies to determine a path with optimal collection and time. Provided herein are derived and solved novel equations that govern and generate the augmented reachable sets or tubes, reachability front, Pareto front, and exact optimal paths for the multi-objective collection, usage, and time optimization problem, given models of information on the dynamic environmental flow fields, dynamic fields to-be-collected or used (for example, collection dynamics), and dynamics of autonomous or other vehicles.

The inventors have recognized and appreciated an increased needs in the importance in the field of autonomy, for example, especially in marine applications involving autonomous underwater vehicles (AUVs) and autonomous surface vehicles (ASVs). One important task in the operation of autonomous or other vehicles is accurate and efficient path planning. For example, path planning may comprise determination of a path for a vehicle to follow such that one or more specific criteria, such as travel time, energy usage, or safety, is enhanced or optimized.

An optimal solution (such as an optimal path) may refer to a planned solution in ideal conditions, while an enhanced solution (such as an enhanced path) may refer to the practical application of the optimized solution. As should be appreciated, an enhanced solution may not necessarily be a perfectly ideal solution in practice. For example, when uncertain information, unknown information, changed information, or other non-ideal information is used to determine an optimal solution, when that optimal solution is applied in practice, it may not necessarily result in perfectly ideal results, due to the uncertain information, unknown information, changed information, or other non-ideal information. For example, if a dynamic flow field or dynamic collectible field is used to determine an optimal path for a vehicle, and the vehicle follows the optimal path in practice, if the dynamic flow field has slight unexpected changes in practice, it may be said that the vehicle followed an enhanced path in practice.

The inventors have recognized and appreciated an important need for allowing additional objectives to be considered in path planning problems is the collection of external fields, which has high practical relevance. One focus of path planning problems with the collection of external fields is collection, usage, and time optimal path planning. Described herein is optimal path planning of autonomous vehicles for collection applications of multiple fields in highly dynamic ocean environments. For example, the disclosure provides the exact solutions to the multi-objective optimization problem of planning paths for autonomous vehicles that minimize the travel time while simultaneously maximizing the amount of one or more material or fields collected by the vehicles.

Collection- and time-optimal path planning may have various applications such as energy harvesting, ocean waste clean (for example, plastic waste cleanup), offshore aquaculture, and other applications including oil spill cleanup, sargassum cleanup, and other applications that may have similar high impact.

With respect to energy harvesting, newer AUV or ASV or other vehicle designs may be equipped with the ability to collect energy from abundant energy sources in the marine or air environment. For example, vehicles may collect solar energy at the water surface, wind energy, wave energy, buoyancy energy, tidal energy, thermal energy, or other energy. Path planning while accounting for energy collected may allow vehicles to operate at sea for increased periods of time.

With respect to ocean plastic waste cleanup, there are large amounts of plastic waste that end up in the oceans. The growth of plastic waste is not slowing, with statistical models projecting that by 2050 there will be more plastic than fish in the sea, by mass. New ASV or other vehicle designs may be used to actively collect such plastic waste. Path planning may be used to enhance or optimize the amount of plastic waste harvested from the environment by such vehicles.

With respect to offshore aquaculture, aspects of the disclosure relate to the growing of marine species by positioning farms in deeper waters further from land. In some embodiments, path planning may be used to provide autonomously moving fish farms. For example, farms may be launched with lab-bred baby fish and navigate along ocean currents to arrive at destinations with fully mature animals ready for market. Collection and time path planning may provide the planning of paths that allow the farms to reach the destination quickly while also enhancing or optimizing nutrient harvestings that increase or maximize fish growth.

The novel equations and methodologies provided herein address considerations related to what governs the motions of a collection or harvesting vehicle that optimally collects a targeted amount of fields in minimum time. The equations and methodologies further address considerations related to how a vehicle (such as an AUV, drone, or other vehicles) with finite energy can move in an environment with strong currents or winds to achieve its goals in the least amount of time and energy usage, which may include, for example, when the vehicle should slow down to conserve energy and when it should speed up to reach the destination quickly. The equations and methodologies further address considerations related to what governs the reachability front when collection and usage fields (for example, culture, debris, energy, or other fields) are optimally collected or harvested from the dynamic environment and when currents or winds are strong and complex. The equations and methodologies further address considerations related to how paths may be predicted that optimally collect dynamic fields and use or avoid currents or winds to reach an end-point in fastest time. The equations and methodologies further address considerations related to how to extend the disclosure to optimize for multiple start and terminal times, all at once, and/or for many coordinated vehicles.

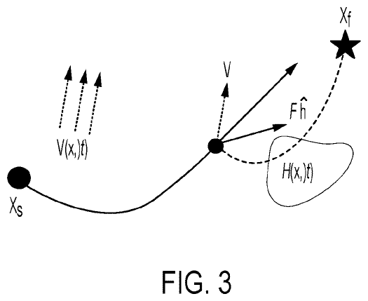

According to aspects of the disclosure, one goal of the equations and methodologies is to find a quickest path for a vehicle from start point to a destination, in a flow in which the vehicle is being advected that is dynamic, while collecting a required amount of background fields that are also dynamic. FIG. 3 shows an illustration of the goal described above.

Conventional methods to address the goal of path planning optimization do not achieve optimal paths. For example, some conventional methods are based on rapidly exploring random trees, A* searches, artificial potential methods. Conventional methods have various issues preventing them from achieving optimal paths. Some issues include that the conventional methods are sub-optimal, heuristic dependent, or only for static fields, are not exact for dynamic fields, do not address joint computation of all collection, usage, and time optimal paths and reachable sets or tubes, among other issues.

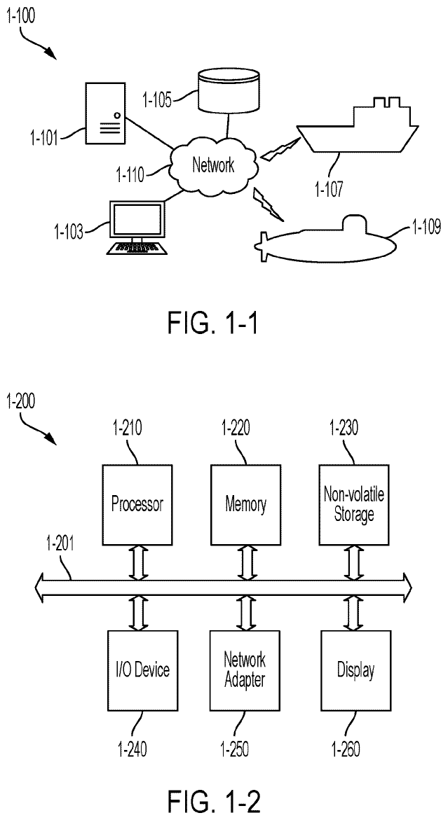

FIG. 1 is a schematic diagram of a route determination system 1-100, according to some embodiments. The route determination system 1-100 includes a computer server 1-101, a computer 1-103, a data storage device 1-105, a first vehicle 1-107, and a second vehicle 1-109, which may be communicatively coupled together by a network 1-110. The network 1-110 comprises one or more networking devices for transmitting information from one point of the network 1-110 to another. The network 1-110 may include a local area network (LAN), a wide area network (WAN), and/or the internet. The network 1-110 may include connections, such as wired links, wireless communications links, and/or fiber optic cables. The network 1-110 may include wireless access points, switches, routers, gateways, and/or other networking equipment as well as any suitable wired and/or wireless communication medium or media for exchanging data between two or more computers, including the Internet. The wireless connections may be implemented using radio signals, optical communication signals, and/or satellite links. Computer server 1-101, computer 1-103, and data storage device 1-105 are illustrated as connected to network 1-110 with a wired connection (either electrical or optical). The first vehicle 1-107 and a second vehicle 1-109 are illustrated as being wirelessly connected to the network 1-110. However, embodiments are not so limited. For example, any of the components may be connected with a wired connection or a wireless connection.

As depicted, the first vehicle 1-107 is illustrated as a shipping vessel and a second vehicle 1-109 is illustrated as a submarine. In some embodiments, the vehicles may be other watercraft such as tankers, bulk carriers, container vessels, passenger vessels, autonomous underwater vehicles (AUVs), sailboats, underwater gliders, or yachts. In other embodiments, the vehicle need not be watercraft. For example, in some embodiments, the vehicles may include aircraft, such as airplanes, helicopters, drones, or unmanned aerial vehicles (UAVs). In some embodiments, the vehicles may be manned or unmanned. In some embodiments, the vehicles may be autonomous or manually controlled by a human operator.

The data storage device 1-105 may be one or more storage devices, such as hard drives, tape drives, optical drives, and other suitable types of devices. The data storage device 1-105 may be located in a single location or may be distributed in different locations. In some embodiments, the data storage device 1-105 may provide data and other information to the computer server 1-101, the computer 1-103, the first vehicle 1-107, or the second vehicle 1-109. For example, the data storage device 1-105 may contain information about the environment associated with one or more vehicles, such as dynamic flow information associated with the air or water. For example, the dynamic flow information may include one or more flow fields.

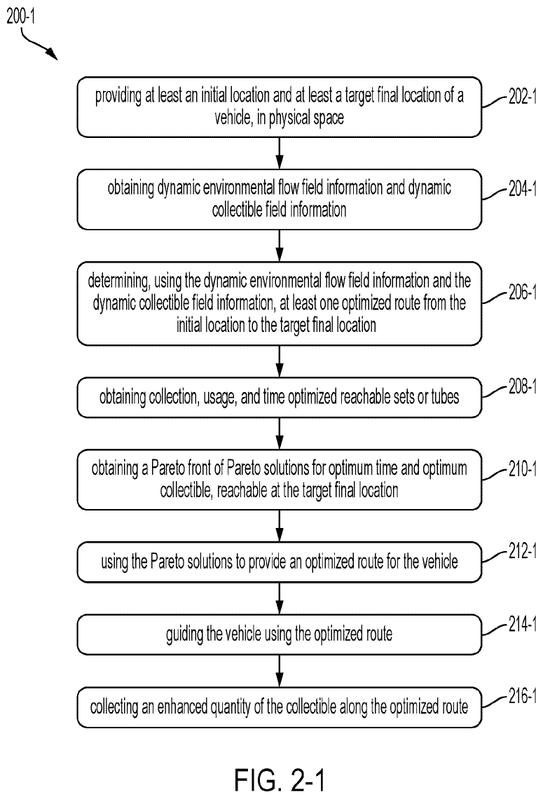

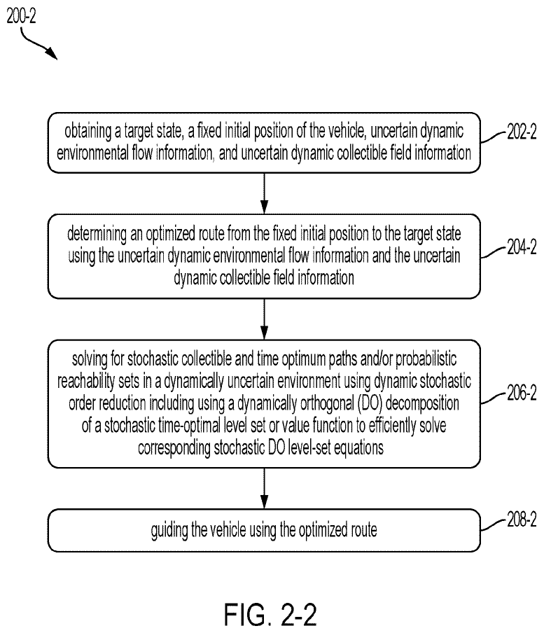

FIG. 1-2 is block diagram of a computing device 2-100 according to some embodiments. The computer server 1-101 or the computer 1-103 may have one or more of the components described in connection with the computing device 2-100. Additionally, the first vehicle 1-107 and/or the second vehicle 1-109 may include a computer with one or more of the components described in connection with the computing device 2-100.

Computing device 2-100 may include at least one computer hardware processor 1-210, a memory 1-220, a non-volatile storage 1-230, an input/output (I/O) device 1-240, a network adapter 1-250, and/or a display 1-260. Computing device 1-200 may be, for example, a desktop or laptop personal computer, a personal digital assistant (PDA), a smart mobile phone, a tablet computer, a computer server, or any other suitable computing device.

Network adapter 1-250 may be any suitable hardware and/or software to enable the computing device 1-200 to communicate wired and/or wirelessly with any other suitable computing device over any suitable computing network, such as network 1-100. The network adapter 1-250 may be used to obtain information from the data storage device 1-105. For example, dynamic flow information and flow uncertainty information may be obtained from the data storage device 1-105.

The display 1-260 may be any suitable display for displaying to a user a visual representation of the optimized route determination results. For example, the display 1-260 may be a computer monitor, an LCD display, or a touchscreen display. The results displayed may include a map, a list of headings, and/or instructions for following the determined route.

The non-volatile storage 1-230 may be adapted to store data to be processed and/or instructions to be executed by processor 602. For example, the non-volatile storage 1-230 may include at least one non-transitory computer-readable storage medium storing processor executable instructions that, when executed by at least one computer hardware processor, such as the processor 1-210, cause the at least one computer hardware processor to perform a method for use in automatically determining an optimized route for a vehicle.

The memory 1-220 may be a volatile memory device such as random-access memory (RAM) that may be controlled by the processor 1-210.

Computer hardware processor 1-210 enables processing of data and execution of instructions. The processor 1-210 may cause computer executable instructions stored in the non-volatile storage 1-230 to be loaded into the memory 1-220. The processor 1-210 may then the instructions to perform a method for use in automatically determining an optimized route for a vehicle.

The data and instructions stored on the non-volatile storage 1-230 may comprise computer-executable instructions implementing techniques which operate according to the principles described herein.

While not illustrated in FIG. 1-2, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

FIG. 2-1 is a flowchart of one method 200-1 related to automatically determining optimized routes for vehicles, according to some embodiments. FIG. 2-2 is a flowchart of another method 200-2 related to automatically determining optimized routes for vehicles, according to some embodiments. The methods 200-1 or 200-2 may be implemented using all or a portion of the route determination system 1-100. For example, a computer on the first vehicle 1-107 or the second vehicle 1-109 may perform all of the actions in the methods 200-1 or 200-2. Alternatively, the server 1-101 and/or the computer 1-103 may perform a portion of the methods 200-1 or 200-2, while other actions of the methods 200-1 or 200-2 may be executed by the first vehicle 1-107 or the second vehicle 1-109. For example, the server 1-101 may determine an optimized route for the first vehicle 1-109 using flow information from data storage device 1-105 and then send information detailing the optimized route to the first vehicle 1-109 where a computer on the first vehicle 1-109 may control the first vehicle 1-109 to implement the optimized route.

At act 202-1, the method 200-1 may include providing an initial location and a target final location of a vehicle, in physical space. At act 204-1, the method 200-1 may include obtaining dynamic environmental flow field information and dynamic collectible field information. At act 206-1, the method 200-1 may include determining, using the dynamic environmental flow field information and the dynamic collectible field information, at least one optimized route from the initial location to the target final location. Act 206-1 may include acts 208-1, 210-1 and 212-1. At act 208-1, the method 200-1 may include obtaining collection, usage, and time optimized reachable sets or tubes. At act 210-1, the method 200-1 may include obtaining a Pareto front of Pareto solutions for optimum time and optimum collectible, reachable at the target final location. At act 212-1, the method 200-1 may include using the Pareto solutions to provide an optimized route for the vehicle. At act 214-1, the method 200-1 may include guiding the vehicle using the optimized route. At act 216-1, the method 200-1 may include collecting an optimized or enhanced quantity of the collectible (for example, in a minimum time) along the optimized route.

At act 202-2, the method 202-2 may include obtaining a target state, a fixed initial position of the vehicle, uncertain dynamic environmental flow information, and uncertain dynamic collectible field information. At act 204-2, the method 202-2 may include determining an optimized route from the fixed initial position to the target state using the uncertain dynamic environmental flow information and the uncertain dynamic collectible field information. Act 204-2 may include act 206-2. At act 206-2, the method 202-2 may include solving for stochastic time optimum paths and/or probabilistic reachability sets in a dynamically uncertain environment using dynamic stochastic order reduction including using a dynamically orthogonal (DO) decomposition of a stochastic time-optimal level set or value function to efficiently solve corresponding stochastic DO level-set equations. At act 208-2, the method 202-2 may include guiding the vehicle using the optimized route.

In some embodiments, one or more computers performing the methods 200-1 or 200-2 may perform the acts described above. For example, any of the computers or servers described above may perform the acts. In some embodiments, a target state includes a desired destination for the vehicle. In some embodiments, the fixed initial position may include the current position of the vehicle. For example, radar or GPS may be used to determine the initial position of the vehicle. The dynamic flow information may include, for example, a flow field. The dynamic flow information and collectible field information may be obtained from a third party, such as a weather service. The dynamic flow information and collectible field information may also include uncertainty information pertaining to the certainty that the flow field is accurate. The dynamic flow information may, for example, be stored on the data storage device 1-105 and obtained via the network 1-110. In some embodiments, the indications of the optimized route may include a list of speeds and/or heading to be implemented by a human operator of the vehicle. In other embodiments, the indications may include a map of the vehicle and its surrounding. In some embodiments, guiding acts may be performed for an autonomous, unmanned vehicle. In other embodiments, guiding acts may be performed even when there is a human operator of the vehicle if, for example, the human operator is operating the vehicle in an autopilot mode.

Returning to the equations and methodologies of the instant disclosure, parameters of the dynamical system may be set out as follows:
Physical domain number of dimensions: d
Number of fields to collect or harvest (for example, collection space dimension): dₕ
Vehicle physical position state space: x∈ [symbol] ^{d}
Vehicle harvest state space: c∈ [symbol] ^{d}^{ₕ}
Vehicle physical position trajectory: Xₚ(t)
Vehicle harvest state trajectory: Cₚ(t)
Background velocity field: V(x, t)
Vehicle speed function: F(t)∈[0, Fₘₐₓ]
Maximum vehicle speed: Fₘₐₓ
Vehicle heading function: ĥ(t)
Start point, in physical space: xₛ
Destination point, in physical space: x_{f}
Starting harvest state: cₛ

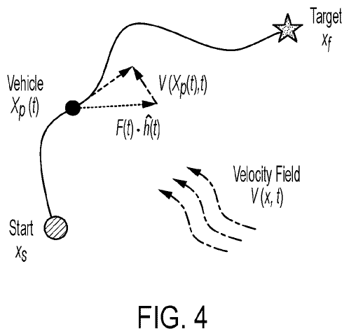

In the dynamical system, vehicle dynamics may be described by Equation 1. The environment of Equation 1 may be illustrated by FIG. 4.

$$\frac{d {X}_{p}}{dt} = V ( {X}_{p} ( t ) , t ) + F ( t ) \hat{h} ( t ) \qquad ( 1 )$$

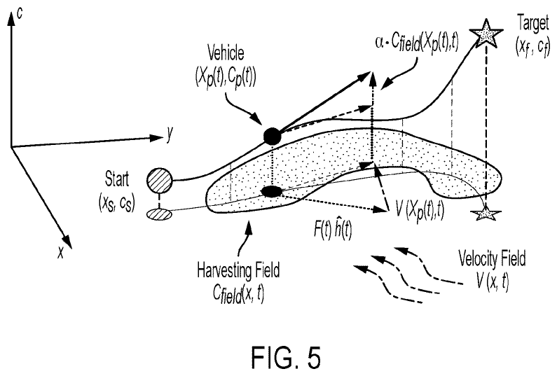

In the dynamical system, collection or harvesting dynamics may be described by Equation 2. The environment of Equation 2 may be illustrated by FIG. 5.

$$\frac{d {C}_{p i}}{d t} = {ℋ}_{i} ( {X}_{p} ( t ) , {C}_{p} ( t ) , F ( T ) , \hat{h} ( t ) , t ) , i = 1 , … , {d}_{h} \qquad ( 2 )$$

For example, Equation 2 as applied to collecting a tracer field may be described by Equation 3.

$$\frac{d {C}_{p}}{dt} = α \cdot {C}_{field} ( {X}_{p} ( t ) , t ) \qquad ( 3 )$$

As another example, Equation 2 as applied to energy collection may be described by Equation 4.

$$\frac{{dE}_{p}}{dt} = \dot{Q} ( {X}_{p} ( t ) , t ) - \dot{W} ( F ( t ) ) \qquad ( 4 )$$

As a further example, Equation 2 as applied to moving farms may be described by Equation 5.

$$\frac{{dH}_{p}}{dt} = Growth Factor ( Nutrition , Sunlight , Salinity , etc . ) \qquad ( 5 )$$

To achieve the goal set out previously, of determining an optimal trajectory in the augmented state space (for example, the physical space and the harvest space), the mathematical optimization problem is set out by Equations 6, 7, 8, 9, 10, 11, and 12.

$$\begin{matrix}\begin{matrix}minimize \\ F ( \cdot ) , \hat{h} ( \cdot )\end{matrix} & [ {t}_{f} , - {C}_{p , 1} ( {t}_{f} ) , - {C}_{p , 2} ( {t}_{f} ) , … , - {C}_{p , {d}_{h}} ( {t}_{f} ) ] & ( 6 ) \\ subject to & {X}_{p} ( 0 ) = {x}_{s} & ( 7 ) \\ & {C}_{p} ( 0 ) = {c}_{s} & ( 8 ) \\ & {X}_{p} ( {t}_{f} ) = {x}_{f} & ( 9 ) \\ & {C}_{p} ( t ) > 0 , ∀ t & ( 10 ) \\ & \frac{{dX}_{p}}{dt} = V ( {X}_{p} ( t ) , t ) + F ( t ) \hat{h} ( t ) & ( 11 ) \\ & \frac{{dC}_{p , i}}{dt} = {ℋ}_{i} ( {X}_{p} ( t ) , {C}_{p} & ( 12 )\end{matrix}$$

According to Equation 6, the disclosure provides for optimizing the path using the vehicle's controls at its disposal, for example, the speed function, and the heading function. Equation 6 further provides the multi-objective problem of minimizing the arrival time and maximizing the vehicle's harvest state upon reaching the destination.

Equations 7, 8, and 9 provide the path's endpoint constraints in the augmented state space (for example, the physical space and the harvest space).

Equations 11 and 12 provide vehicle dynamics constraints, for example, position state and harvest states.

According to the equations above, the optimization method is a multi-objective method. One important challenge in multi-objective optimization is that, in some cases, for example, a vast majority of cases, there may be no globally optimal solution that minimizes all objectives. Accordingly, the disclosure therefore searches for Pareto optimal solutions. With respect to Pareto optimal solutions, a general multi-objective optimization problem is provided by Equations 13 and 14.

$$\begin{matrix}\begin{matrix}minimize \\ x\end{matrix} & [ {f}_{1} ( x ) , {f}_{2} ( x ) , … , {f}_{k} ( x ) ] & ( 13 ) \\ subject to & x ∈ 𝒮 & ( 14 )\end{matrix}$$

A Pareto optimal solution is one which cannot be improved upon in an objective without degrading the performance of another. For example, refer to the following definition.

Definition 2.1. A decision vector x*∈ [symbol] is Pareto optimal if there does not exist another decision vector x∈ [symbol] such that fᵢ(x)≤|fᵢ(x*) for all i=1, . . . , k and fᵢ(x)<fᵢ(x*) for at least one index j.

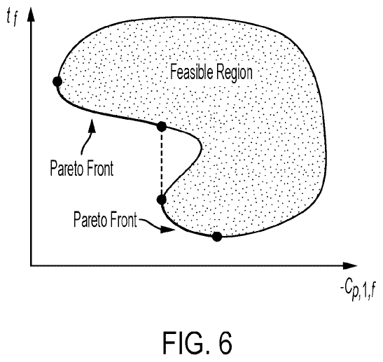

A full set of Pareto optimal solutions may be referred to as the Pareto front. A Pareto front is illustrated in FIG. 6. According to aspects of the disclosure, the equations and methodology may provide a theory that governs, and methodology that efficiently computes, the set of Pareto optimal solutions to the multi-objective collection, usage, and time path planning problem in dynamic environments.

Some example problems that may be solved according to the provided theory and methodology are as follows. For example, what is the an optimal path of a solar vehicle that reaches a destination in fastest time and with at least 10% battery? When a vehicle starts with 90% battery level, what are the regions in the ocean or airspace that it can travel over the course of 2 days without letting the battery level fall below 5%? How quickly a cleanup vehicle can collect 2 tons of plastic? What is the maximum amount of plastic or oil that a cleanup vehicle can collect in 2 days. How should a moving fish farm travel such that it can support the maximum growth of fish and end up back at the start point after 2 weeks? What is the path that a solar powered vehicle should follow such that it charges up its battery to the maximum capacity in five days, regardless of where it ends up? Among all possible start times in the next 2 days, what is the optimal start time and location for a vehicle so as to maximize the harvest of environmental energy, sargassum clean-up, and/or carbon sequestration in the next week?

According to aspects of the disclosure, the collection and time optimal reachability front may be obtained. For collection-time optimality, the reachable set may be the set of all augmented states (for example, in physical and harvest spaces) that the vehicle can reach at a given time. The reachability front is the outer edge of that set. The disclosure provides a new derived partial differential equation (PDE) that governs the set and front exactly (for example, without no heuristics, or other similar methods). The PDE governs an implicit variable (φ) in the augmented state space, such that its zero level set is the reachability front,

The augmented state space (for example, physical x state and harvest c state), may be provided by Equation 15.

$${x}^{a} = [ \begin{matrix}x \\ c\end{matrix} ] \qquad ( 15 )$$

Augmented system dynamics may be provided by Equations 16, 17, 18, 19, and 20.

$$\frac{d {X}_{p}}{dt} = V ( {X}_{p} ( t ) , t ) + F ( t ) \hat{h} ( t ) \qquad ( 16 )$$

$$\frac{d {C}_{ρ}}{dt} = ℋ ( {X}_{p} ( t ) , {C}_{p} ( t ) , F ( t ) , \hat{h} ( t ) , t ) \qquad ( 17 )$$

$$ℋ = {[ {H}_{1} , {H}_{2} , … , {H}_{R} ]}^{T} \qquad ( 18 )$$

$$c = {[ {c}_{1} , {c}_{2} , … , {c}_{R} ]}^{T} \qquad ( 19 )$$

$$R = Number of collection fields \qquad ( 20 )$$

From the Equations, provided is a derived PDE in Equations 21 and 22, whose characteristics are dynamics that maximally grow level sets of φ. The PDE governs the evolution of the reachability set and front.

$$\frac{\partial ϕ ( x , c , t )}{\partial t} + \begin{matrix}max \\ F , \hat{h}\end{matrix} \{ F \cdot {\hat{h}}^{T} \cdot \frac{\partial ϕ}{d x} + {ℋ ( x , c , F , \hat{h} , t )}^{T} \cdot \frac{\partial ϕ}{\partial c} \} + {V ( x , t )}^{T} \cdot \frac{\partial ϕ}{\partial x} = 0 \qquad ( 21 )$$

$$ϕ ( x , c , t = 0 ) = {ϕ}_{0}$$

To obtain the Pareto front, the complete set of Pareto optimal solutions, holding solutions of the form (t*, c*) the Pareto front may be extracted from the reachability front. For example, refer to the following claim.

Claim 2.1. All Pareto optimal solutions (t*, c*) to the optimization problem given by Equation 6 lie in the set {(t*, c*)|φ(x=x_{f}, c*, t*)=0}. That is, all Pareto optimal solutions lie on the reachability front.

The Pareto front may be obtained exactly by tracking the reachability front's evolution at the destination. For example, for a single collection dimension case, consider a time \hat{t}. Let the set of Pareto optimal solutions from times t<\hat{t} be denoted by Θₚ. Consider the set [symbol] _{c}={c|φ(x=x_{f}, c, t=\hat{t})=0}. If [symbol] _{c} is non-empty, the candidate Pareto optimal solution is ĉ=max( [symbol] _{c}). If ĉ is bigger than the max c in Θₚ, then (\hat{t}, ĉ) is a Pareto optimal solution and can be added to Θₚ. Repeat for all subsequent time steps.

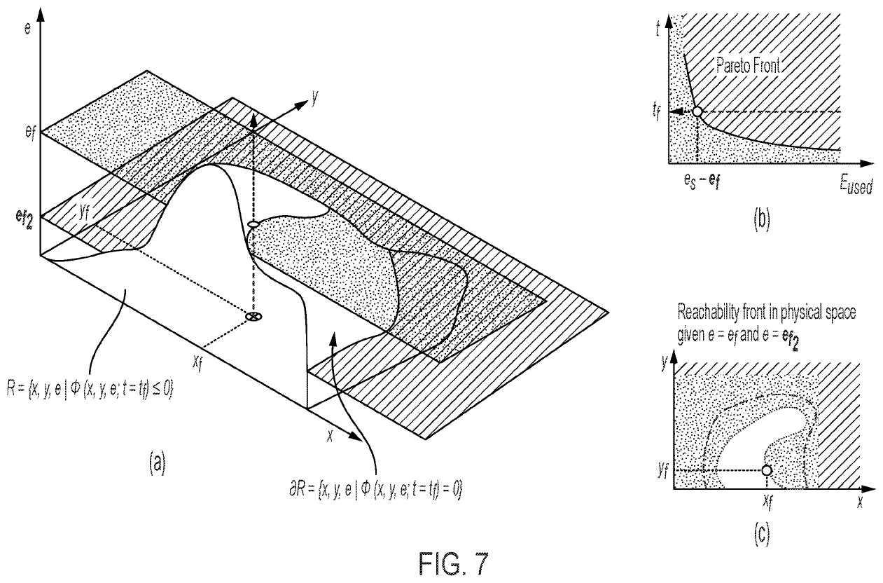

FIG. 7 shows a schematic for the reachability set and the Pareto front (for c₁=e). The Pareto front at a physical position, marked by x, shows the amount of energy, or a harvested amount, a vehicle may have at that position as a function of the arrival time. The set of reachable states ( [symbol] ) in the augmented state space, given by (φ<0) is the set of all positions and energy, and/or any other harvested amounts, that the vehicle can reach given the physical position.

Next, the optimal path may be obtained for a Pareto optimal solution. Once the Pareto front has been generated, Pareto optimal solutions are selected by a decision maker who expresses preference for their objectives of interest. For example, a preference may relate to how much to trade-off the final amount collected with the time of arrival. The optimal speed and heading functions, within the maximizers of the reachability PDE, may be given by Equations 23 and 24.

$${F}^{*} ( x , c , t ) \qquad ( 23 )$$

$${\hat{h}}^{*} ( x , c , t ) \qquad ( 24 )$$

Chosen solutions may be considered from the Pareto front of the form of Equation 25.

$$[ {t}_{f}^{*} , {c}_{f}^{*} ] \qquad ( 25 )$$

The optimal trajectory of the system through the augmented state space

$${X}_{p}^{a}$$

is governed by, and may be obtained by solving, the Backtracking Ordinary Differential Equation (ODE) backwards in time, shown in Equations 26, 27, 28, and 29.

$$\frac{d {X}_{p}^{a}}{dt} = - {U}_{*}^{a} ( {X}_{p}^{a} ( t ) , t ) - {V}^{a} ( {X}_{p}^{α} ( t ) , t ) \qquad ( 26 )$$

$${X}_{p}^{a} ( t ) = [ \begin{matrix}{X}_{p} ( t ) \\ {C}_{p} ( t )\end{matrix} ] \qquad ( 27 )$$

$${U}_{*}^{a} ( {X}_{p}^{a} ( t ) t ) = [ \begin{matrix}{F}^{*} ( {X}_{p}^{a} ( t ) , t ) \cdot {\hat{h}}^{*} ( {X}_{p}^{a} ( t ) , t ) \\ ℋ ( {X}_{p} ( t ) , {C}_{p} ( t ) , {F}^{*} ( {X}_{p}^{a} ( t ) , t ) , {\hat{h}}^{*} ( {X}_{p}^{a} ( t ) , t ) , t )\end{matrix} ] \qquad ( 28 )$$

$${V}^{a} ( {X}_{p}^{a} ( t ) , t ) = [ \begin{matrix}V ( {X}_{p} ( t ) , t ) \\ 0\end{matrix} ] \qquad ( 29 )$$

These equations may provide the final condition, solving for optimal path backwards in time starting from the endpoint in the augmented space.

Now, equations associated with particular cases of collection and time optimal path planning are provided. Importantly, these PDEs and ODEs exactly solve the multi-objective path planning problem.

First, the disclosure provides equations referring to energy and time optimal path planning. The augmented state space for energy and time optimal path planning is provided by Equation 30.

$${x}^{a} = [ \begin{matrix}x \\ e\end{matrix} ] \qquad ( 30 )$$

The collection dynamics for energy and time optimal path planning are provided by Equation 31.

$$\frac{{dE}_{p}}{dt} = \dot{Q} ( {X}_{p} ( t ) , t ) - k \cdot {F ( t )}^{n} \qquad ( 31 )$$

The reachable front evolution (for example, augmented space) for energy and time optimal path planning is provided by Equation 32.

$$\frac{\partial ϕ ( x , e , t )}{\partial t} + {F}^{*} ( x , e , t ) ‖ \frac{\partial ϕ}{\partial x} ‖ + {V ( x , t )}^{T} \cdot \frac{\partial ϕ}{\partial x} + [ \dot{Q} ( x , t ) - k \cdot {[ {F}^{*} ( x , e , t ) ]}^{n} ] \cdot \frac{\partial ϕ}{\partial e} = 0 \qquad ( 32 )$$

Optimal controls to be used in the Backtracking ODE for energy and time optimal path planning are provided by Equations 33 and 34.

$${F}^{*} ( x , e , t ) = \{ \begin{matrix}{F}_{max} & if \frac{\partial ϕ}{\partial E} \leq 0 \\ min ( {F}_{max} , {( \frac{‖ \frac{\partial ϕ}{\partial x} ‖}{k \cdot n \cdot \frac{\partial ϕ}{\partial E}} )}^{\frac{1}{n - 1}} ) & if \frac{\partial ϕ}{\partial E} > 0\end{matrix} \qquad ( 33 )$$

$${\hat{h}}^{*} ( x , e , t ) = \frac{\frac{\partial ϕ}{\partial x} {\vert}_{( x , e , t )}}{‖ \frac{\partial ϕ}{\partial x} {\vert}_{( x , e , t )} ‖} \qquad ( 34 )$$

Next, the disclosure provides equations referring collection and time optimal path planning (for example, for collecting a tracer field). The augmented state space for collection and time optimal path planning is provided by Equation 35.

$${x}^{a} = [ \begin{matrix}x \\ c\end{matrix} ] \qquad ( 35 )$$

The collection dynamics for collection and time optimal path planning are provided by Equation 36.

$$\frac{d {C}_{p}}{dt} = α \cdot {c}_{field} ( {X}_{p} ( t ) , t ) \qquad ( 36 )$$

The reachable front evolution (for example, augmented space) for collection and time optimal path planning is provided by Equation 37.

$$\frac{\partial ϕ ( x , c , t )}{\partial t} + {F}_{max} ‖ \frac{\partial ϕ}{\partial x} ‖ + {V ( x , t )}^{T} \cdot \frac{\partial ϕ}{\partial x} + α \cdot {C}_{field} ( x , t ) \frac{\partial ϕ}{\partial c} = 0 \qquad ( 37 )$$

Optimal controls to be used in the Backtracking ODE for collection and time optimal path planning are provided by Equations 38 and 39.

$${F}^{*} ( x , c , t ) = {F}_{max} \qquad ( 38 )$$

$${\hat{h}}^{*} ( x , c , t ) = \frac{\frac{\partial ϕ}{\partial x} {\vert}_{( x , c , t )}}{‖ \frac{\partial ϕ}{\partial x} {\vert}_{( x , c , t )} ‖} \qquad ( 39 )$$

Methodology and numerical implementation are described. The PDEs and ODEs used by the theory may be numerically solved. For example, for the reachability PDEs, high-order methods on structured, uniform meshes may be used. In some embodiments, care must be taken in numerically solving the PDEs. For example, Monotone Schemes may be used to solve these equations, as these equations may fall in the family of Hamilton-Jacobi PDEs. In some embodiments, variants of the Lax-Friedrichs scheme (for example, Local Lax-Friedrichs Scheme, Global Lax-Friedrichs Scheme, and other schemes) may be used to numerically compute the solution of the reachability PDE. In some embodiments, the Backtracking ODEs may be solved using explicit or implicit schemes.

Aspects of the disclosure relate to Hamilton-Jacobi forward reachability. The equations and methodologies described herein may use the concept of forward reachability. For example, Equation 40 provides a general dynamical system, with controls u(t).

$$\frac{d x}{dt} = f ( x ( t ) , u ( t ) , t ) , x ( {t}_{0} ) = {x}_{0} , t ∈ [ {t}_{0} , {t}_{f} ] \qquad ( 40 )$$

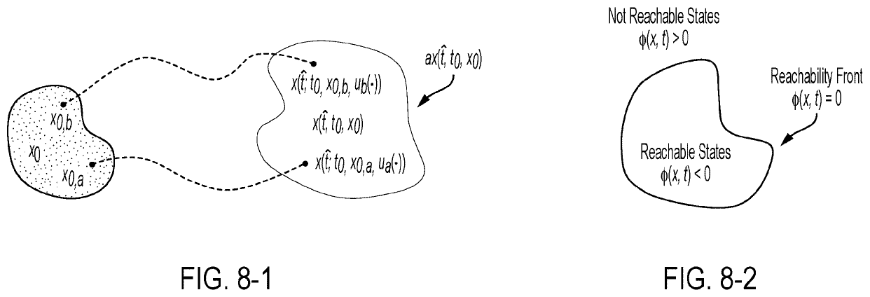

Considering the set of possible initial sets of the system [symbol] . The forward reachable set at a time \hat{t} is the set of all states the system could be in at the time \hat{t}. This set is exact and accounts for all possible control functions a vehicle could have used. The boundary of this set is known as the forward reachability front. For example, FIGS. 8-1 shows the forward reachability front ∂ [symbol] (\hat{t}, t₀, [symbol] ₀) and FIG. 8-2 shows reachable states φ(x, t)<0, not reachable states φ(x, t)>0, and the reachability front φ(x, t)=0.

To evolve the forward reachable set or front, the Level Set Method may be used. The Level Set Method may efficiently compute this set at any time. The Level Set Method may use a function φ to implicitly define the set, where the front is defined as the zero level set. Equation 41 shows the state reachable at time t.

$$ϕ ( x , t ) < 0 \qquad ( 41 )$$

Equation 42 shows the state on reachability front at time t.

$$ϕ ( x , t ) = 0 \qquad ( 42 )$$

Equation 43 shows the state not reachable at time t.

$$ϕ ( x , t ) > 0 \qquad ( 43 )$$

The Forward Reachability PDE (initial value problem) tells us exactly how φ evolves. The PDE is provided by Equation 44.

$$\frac{\partial ϕ ( x , t )}{\partial t} + \begin{matrix}max \\ u\end{matrix} \{ {f ( x , u , t )}^{T} \cdot \frac{\partial ϕ ( x , t )}{\partial x} \} = 0 \qquad ( 44 )$$

The initial condition of the PDE are provided by Equation 45.

$$ϕ ( x , t = {t}_{0} ) = d ( x , \partial {X}_{0} ) \qquad ( 45 )$$

In some embodiments, a deductive forward computation of optimized trajectories of vehicles operating in dynamic and uncertain flows may be determined with a computational efficiency that is one or two orders of magnitude better than conventional techniques. In some embodiments, a time-optimized route to a target state is determined by starting with a fixed initial position and determining a forward reachable set of fronts using an unsteady Hamilton-Jacobi (HJ) equation.

In some embodiments, combining decision theory with stochastic path-planning can result in a new partial differential equation-based scheme for risk optimal route planning in uncertain and dynamic flows. By combining a principled risk optimality criterion grounded in decision theory with stochastic dynamical orthogonal level-set equations, an efficient computational scheme to predict optimized paths from a distribution of stochastic optimized paths is determined.

In some embodiments, accounting for uncertainty in optimized route path planning results is important for many applications. To efficiently solve the partial differential equations involved, some embodiments use dynamically orthogonal reduced-order projections that result in several orders of magnitude in computational speed-up relative to Monte Carlo techniques.

One challenge in dynamic reachability forecasting and optimal path planning for realistic ocean conditions is that current forecasts are uncertain. There could be uncertainties in the initial conditions, boundary conditions, parameters and even terms in the equations themselves. In the present disclosure, one objective is to provide fundamental and efficient stochastic equations and methodology for computing the reachability fronts and time-optimal paths of vehicles navigating in uncertain, strong, and dynamic flow fields. As may be seen, such an approach also helps us in quantifying the sensitivity of optimal paths to errors in flow predictions.

Provided is a theory for rational risk-optimal path planning by combining decision theory and stochastic time-optimal path planning with stochastic DO level-set equations. The schemes and software developed compute risk-optimal paths for vehicles navigating in uncertain, strong and dynamic flows. The path planning proceeds in three steps: (i) obtain predictions of the probability distribution of environmental flows, (ii) obtain predictions of the distribution of exact time-optimal paths for the above flow distribution, and (iii) compute and minimize the risk of following the above time-optimal paths. Three cost functions corresponding to risk-seeking, risk-neutral and risk-averse behaviors may be utilized to compute and minimize risk. The disclosure illustrates the planning in various stochastic flow scenarios. The risk-optimal paths minimize the error of following the chosen path, if it is not the exact time-optimal path for that environmental flow realization. Minimizing a risk-seeking cost function results in a path that has a higher probability of being closer to the exact time-optimal path, but also a higher probability of being far away from the exact time-optimal path. A risk-averse path on the other hand has a high probability of medium error, and a low probability of either extremes (being very close or very far from the exact time optimal path). In complex flow situations, it is difficult to predict the behavior a-priori as shown in the stochastic flow exiting a strait example. Here, the methodology may allow in the characterization and minimization of the risks along time-optimal paths.

Further description related to dynamically orthogonal (DO) decomposition, Hamilton-Jacobi (HJ) equations, and other aspects related to the present disclosure may be found in U.S. Provisional Patent Application Ser. No. 62/689,011 entitled “OPTIMAL SHIP ROUTING IN STRONG, DYNAMIC, AND UNCERTAIN OCEAN CURRENTS AND WAVES,” filed Jun. 22, 2018, and U.S. patent application Ser. No. 16/449,305, now U.S. Pat. No. 11,435,199, entitled “ROUTE DETERMINATION IN DYNAMIC AND UNCERTAIN ENVIRONMENTS,” filed Jun. 21, 2019, each of which is hereby incorporated herein by reference in its entirety.

Exemplary applications of determining paths with enhanced or optimal collection and time are now described. Some aspects of the technology described herein may be understood further based on the disclosure and illustrative non-limiting examples provided in the examples below. Each of the examples may be considered to be self-contained such that equations referenced in each example only refer to the equation in the respective example.

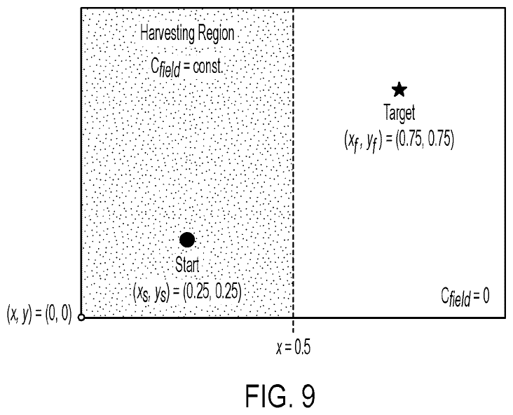

A first example is provided for a halfspace collection region benchmark case. In the example, a simple idealized case consisting of collecting a tracer field is considered. FIG. 9 shows the collectible field of this example. Equation 46 provides dynamics for collecting a tracer field according to this example.

$$\frac{{dc}_{p}}{dt} = α \cdot {C}_{field} ( {X}_{p} ( t ) , t ) \qquad ( 46 )$$

The environment is steady, and the field to be collected covers only a halfspace. This halfspace case provides a good benchmark of the methods since it admits an analytical solution that can be compared with numerical results.

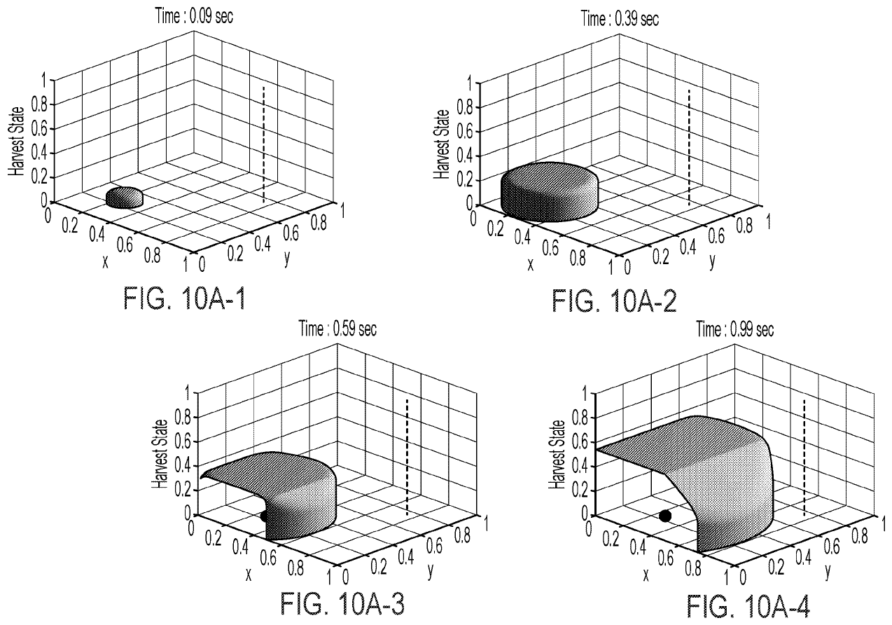

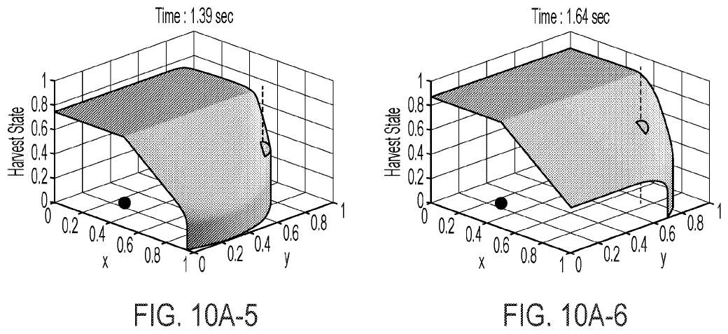

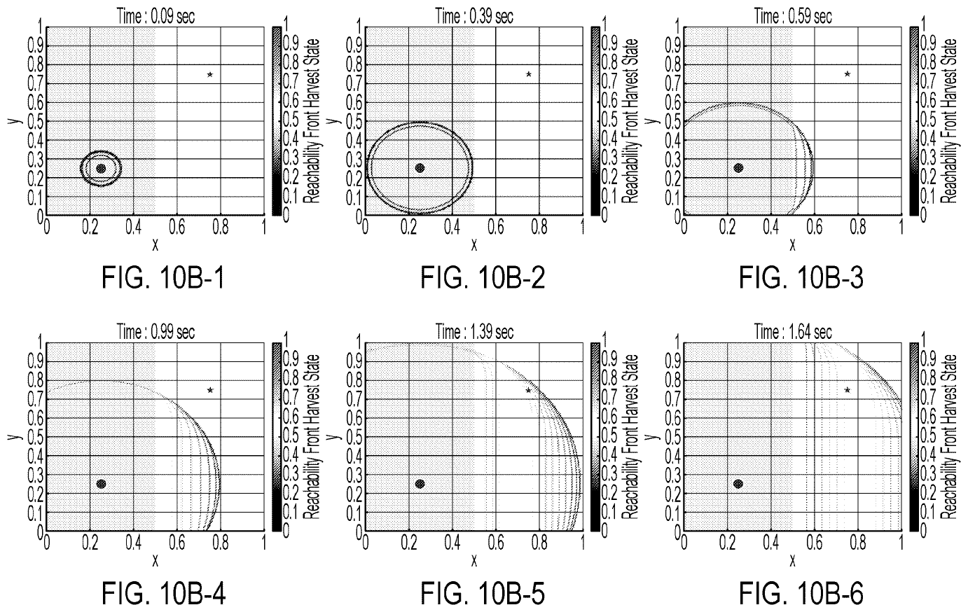

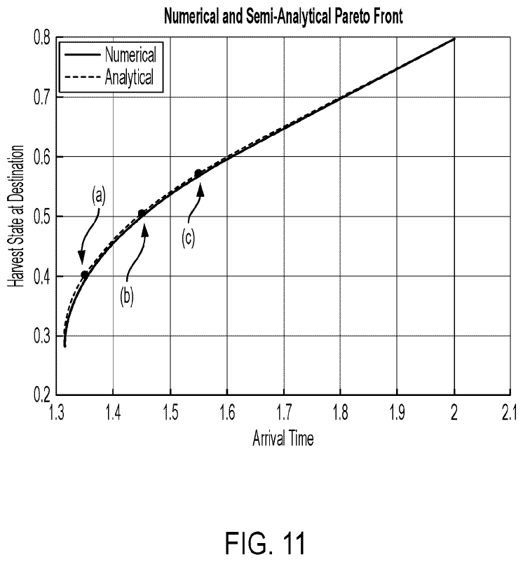

FIGS. 10A-1 through 10A-6 show a perspective view of and FIGS. 10B-1 through 10B-6 show a top-down view of the reachability front evolution for the halfspace collection region benchmark case.

FIG. 11 shows a numerical and semi-analytical Pareto front for the same halfspace collection region benchmark case.

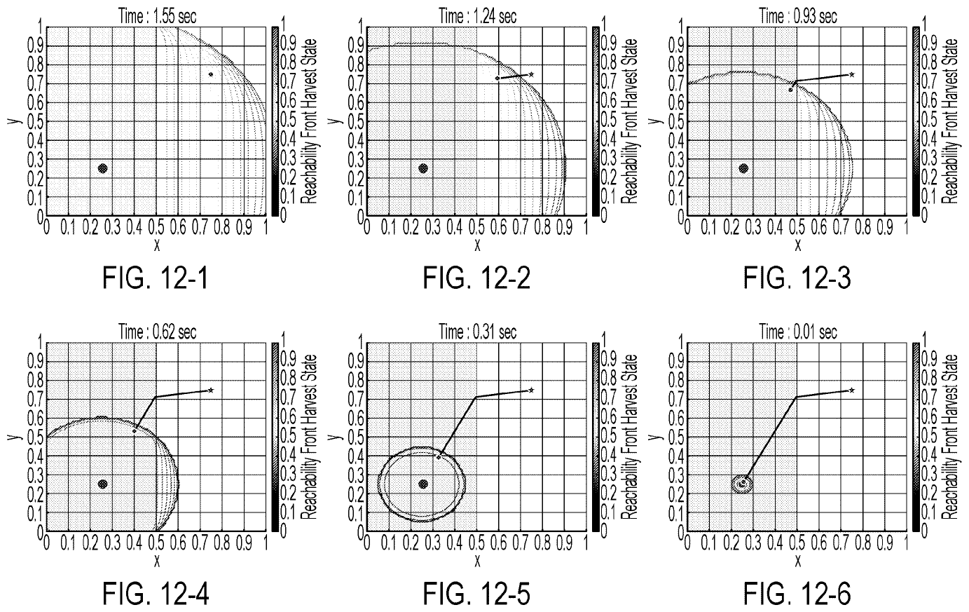

FIGS. 12-1 through 12-6 backtracking a numerical optimal path for the halfspace collection region benchmark case.

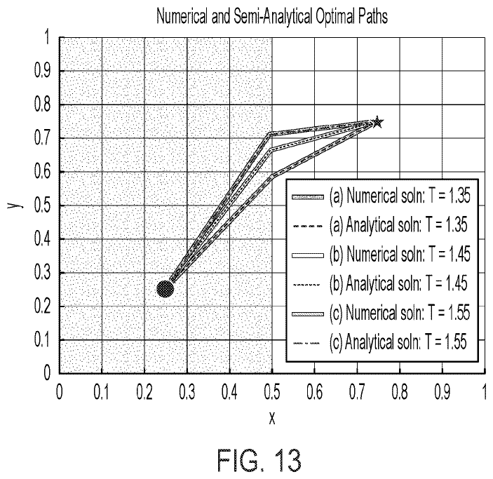

FIG. 13 shows numerical and semi-analytical optimal paths for the halfspace collection region benchmark case.

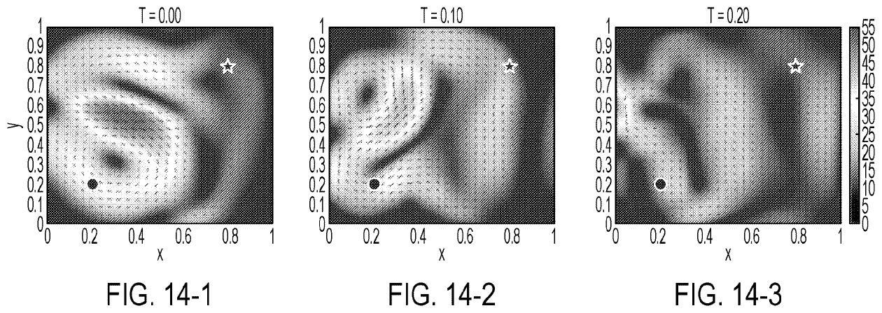

A second example of energy and time optimal path planning is provided for a double gyre ocean circulation. In the example, energy and time optimal path planning in a highly dynamic flow field is considered. The example simulates near-surface ocean circulations at mid latitude regions, where winds drive a cyclonic and anticyclonic gyre with a jet in between. FIGS. 14-1 through 14-3 illustrate the idealized double gyre flow of this example.

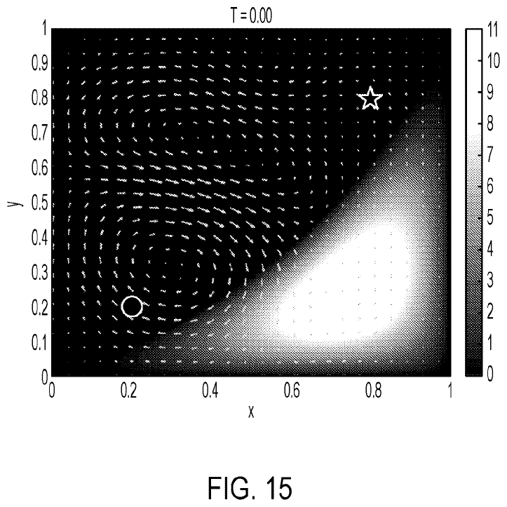

The parameters of the example are as follows. An ASV is equipped with energy collection capabilities to collect energy from a steady energy input field in the environment. FIG. 15 illustrates the steady energy input field. The ASV controls are heading and speed, with a maximum speed of F=4. The goal of the example is to navigate from (0.2, 0.2) to (0.8, 0.8) while minimizing time and maximizing the energy of the vehicle remaining (for example, minimizing net energy use. The vehicle starts with 0.5 units of energy.

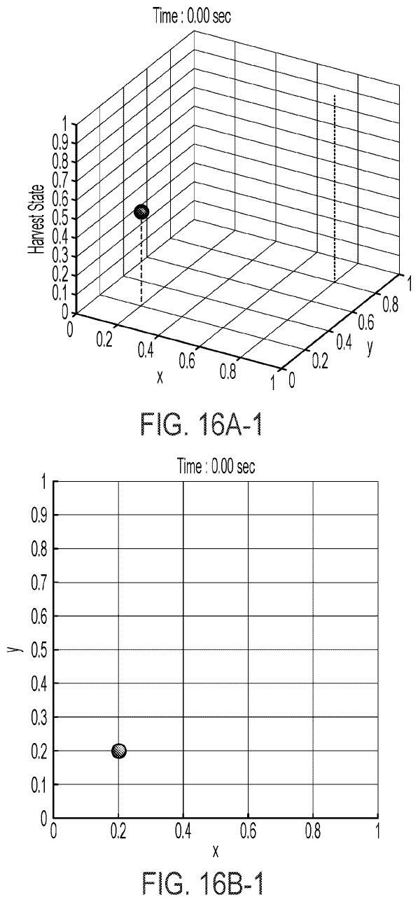

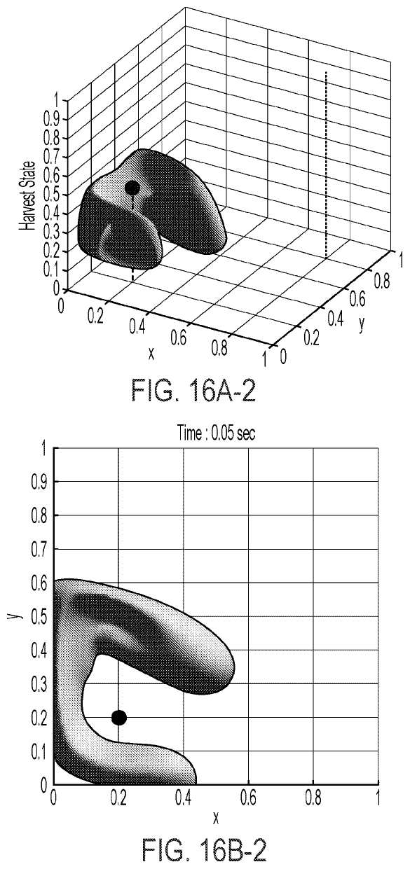

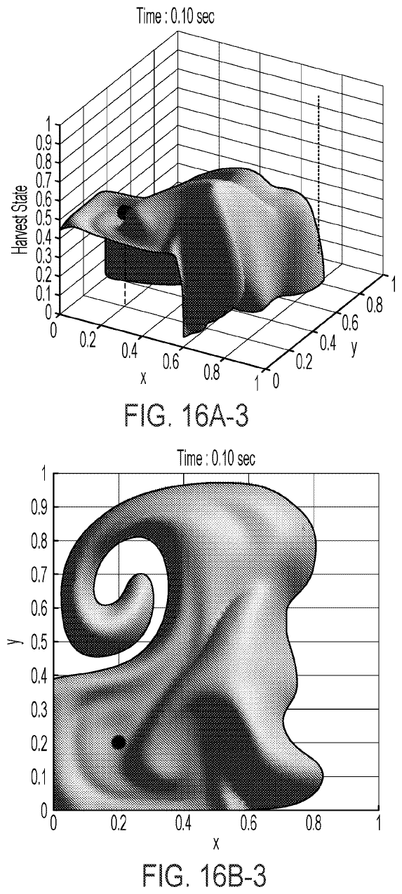

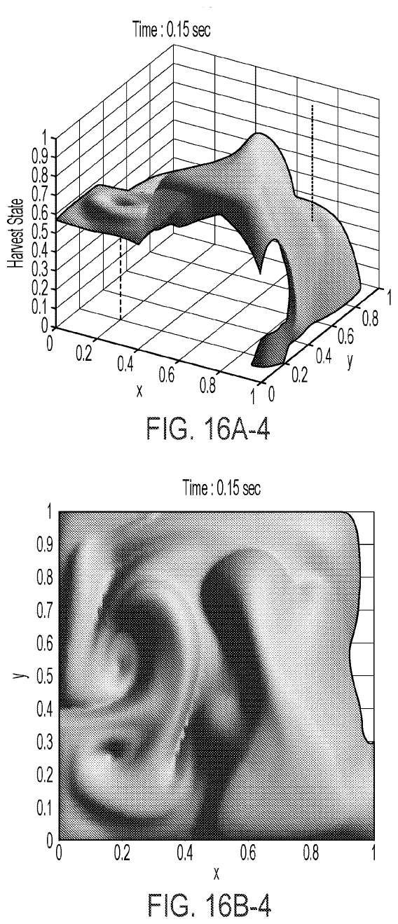

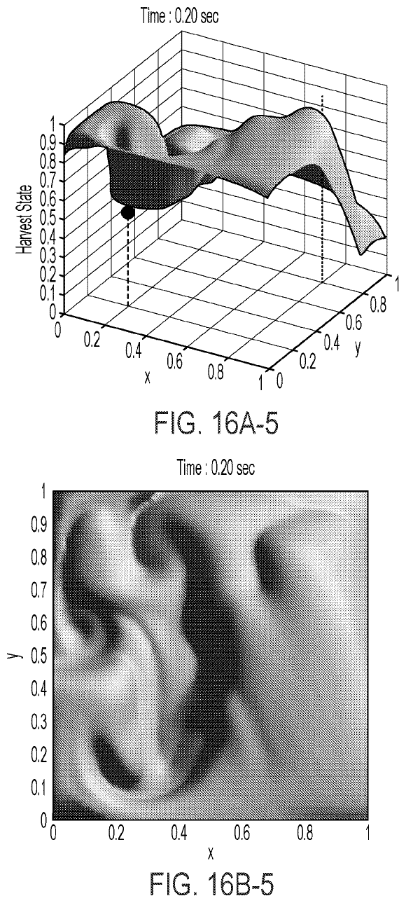

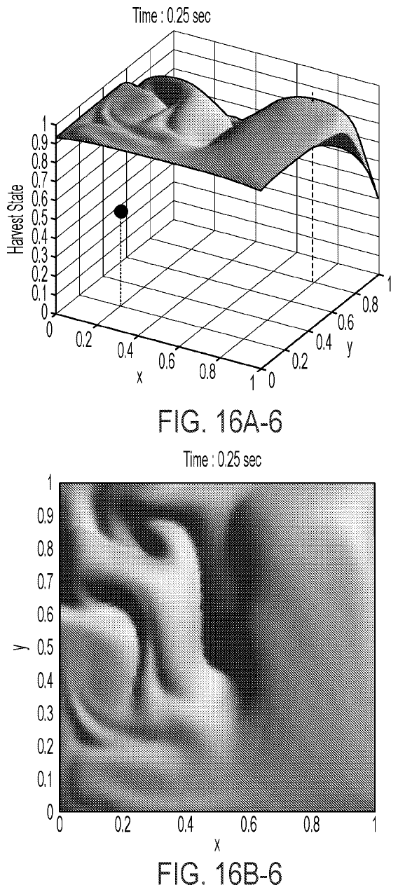

FIGS. 16A-1 through 16A-6 show a perspective view of and FIGS. 16B-1 through 16B-6 show a top-down view of the reachability front evolution for the energy and time optimal path planning for the double gyre ocean circulation case.

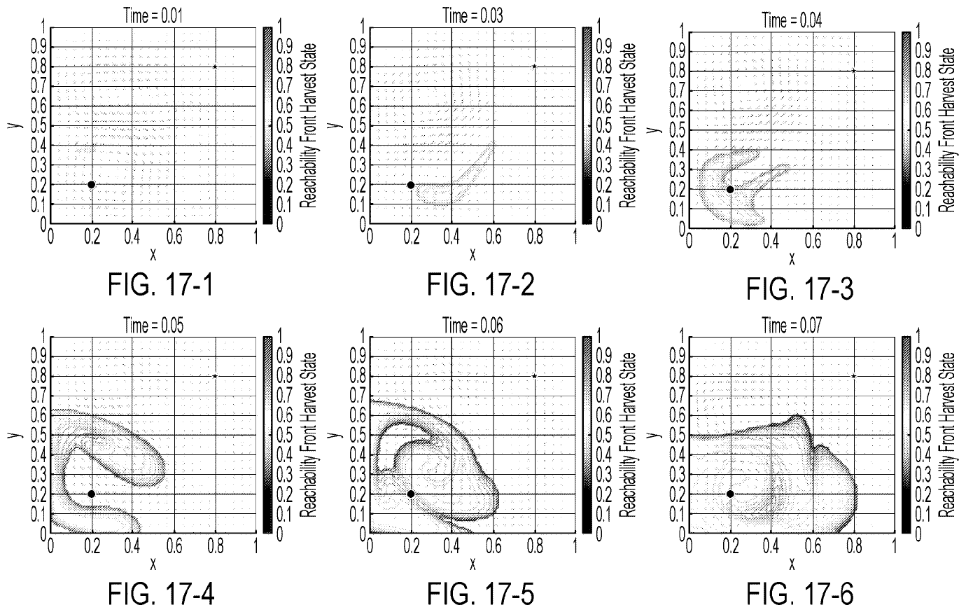

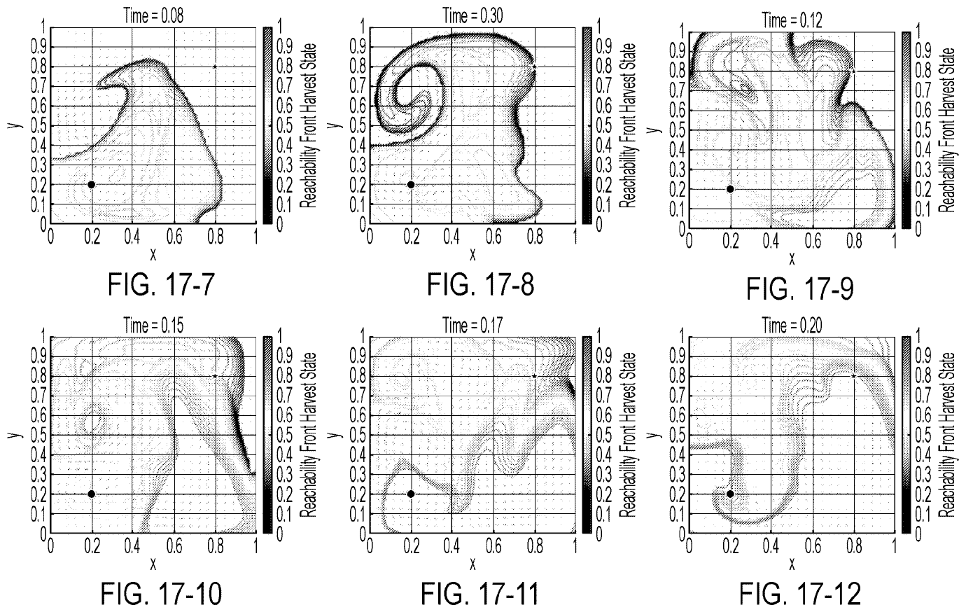

FIGS. 17-1 through 17-12 show a top-down view of the reachability front evolution with the reachability front energy state, for the energy and time optimal path planning for the double gyre ocean circulation case.

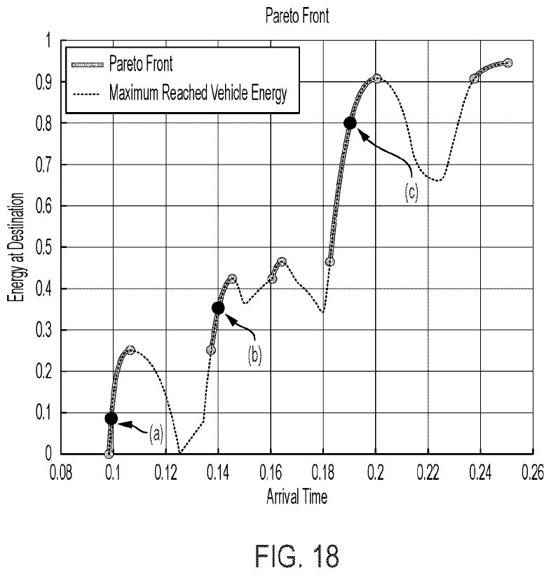

FIG. 18 shows a Pareto front for the energy and time optimal path planning for the double gyre ocean circulation case.

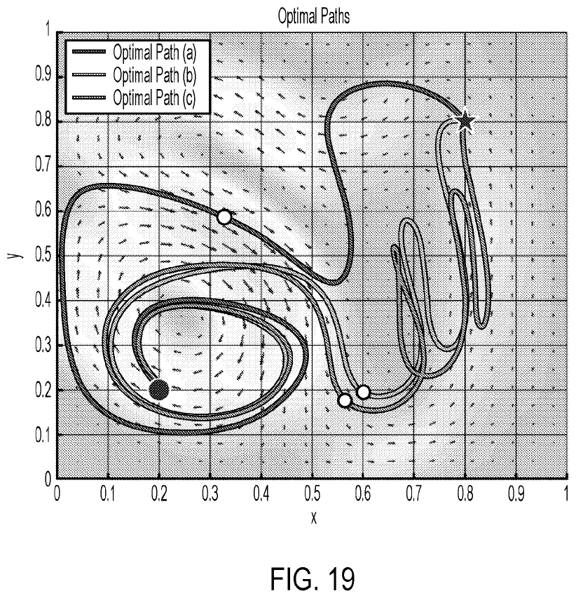

FIG. 19 shows a top-down view of energy-time optimal paths for the energy and time optimal path planning for the double gyre ocean circulation case.

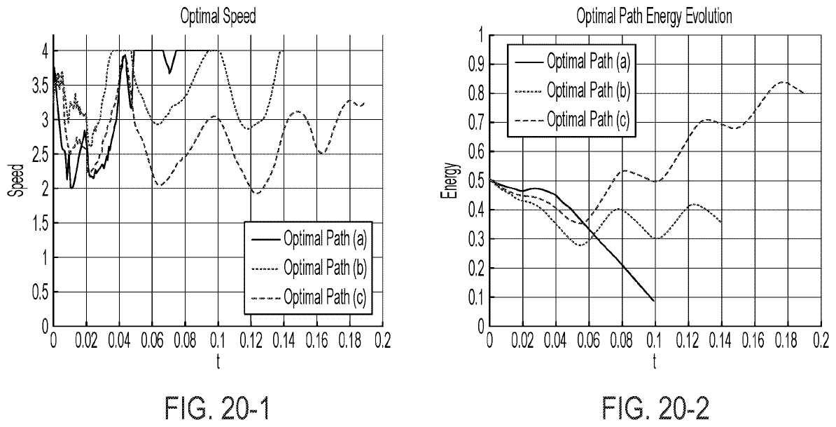

FIGS. 20-1 and 20-2 show optimal speed and optimal energy path evolution for the energy-time optimal paths for the energy and time optimal path planning for the double gyre ocean circulation case.

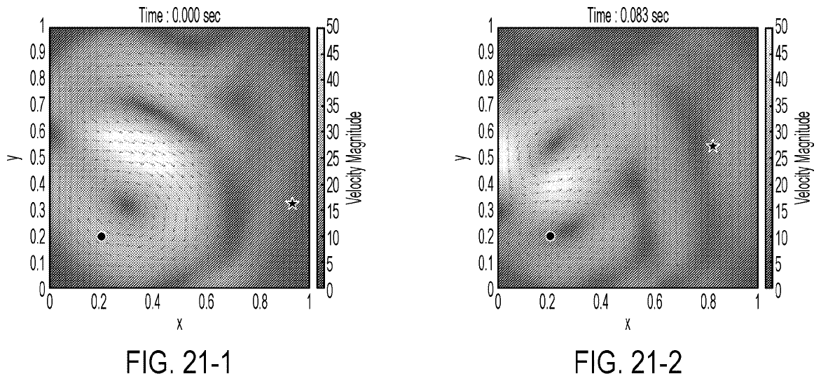

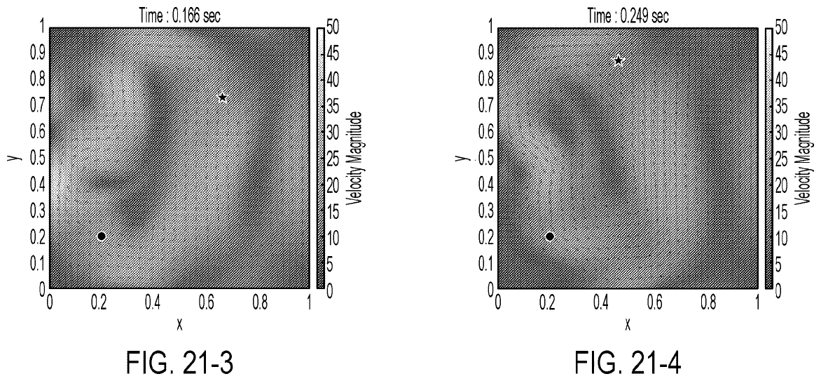

A third example of energy and time optimal path planning is provided for double gyre ocean circulation with target intercept. In this case, a slight variation of the previous results is provided, and a moving target that the vehicle wants to intercept is provided. In this case, heading may be the only control, as speed may be fixed. In other examples, this can be extended through to a variable speed case. The same flow field as the previous example is provided, idealized double-gyre. FIGS. 21-1 through 21-4 illustrate the idealized double gyre flow with the moving target of this example.

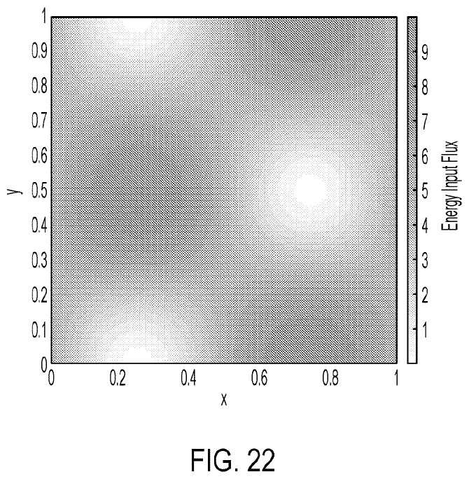

This example again uses a steady energy input field. FIG. 22 illustrates the steady energy input field. For simplicity of this example, the full Pareto front may not be traced, but instead a path corresponding to a point on this front may be directly computed. The parameters of this example are as follows. Starting with non-dimensional energy of 0.3, the ASV must reach the target with at least 0.6 units of energy in a time-optimal manner.

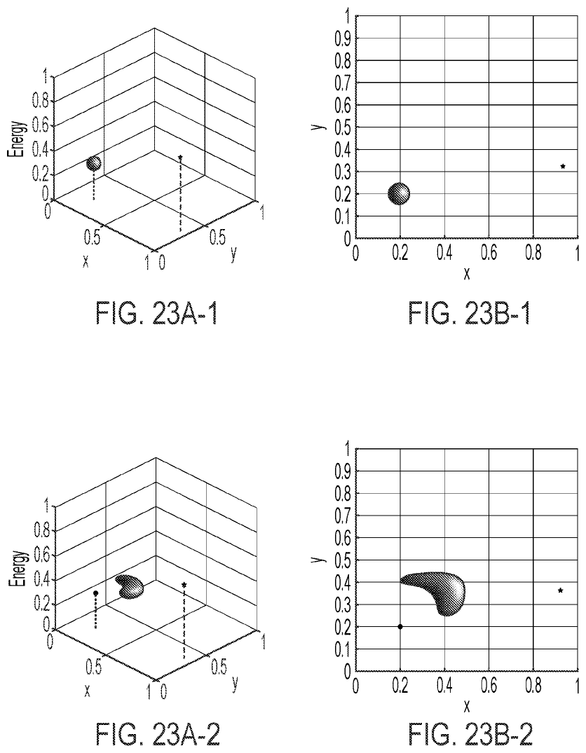

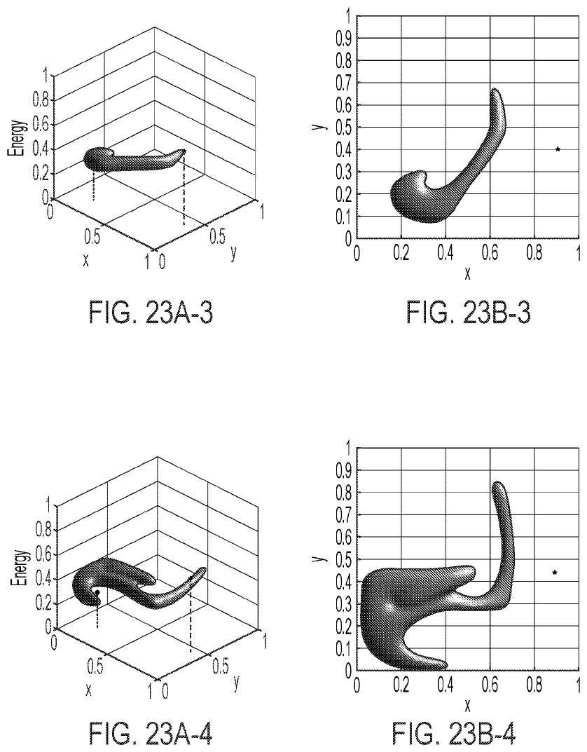

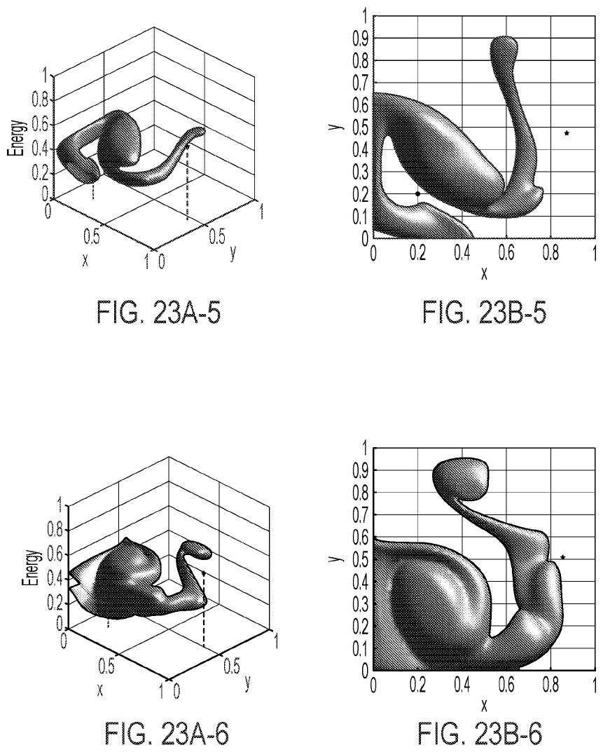

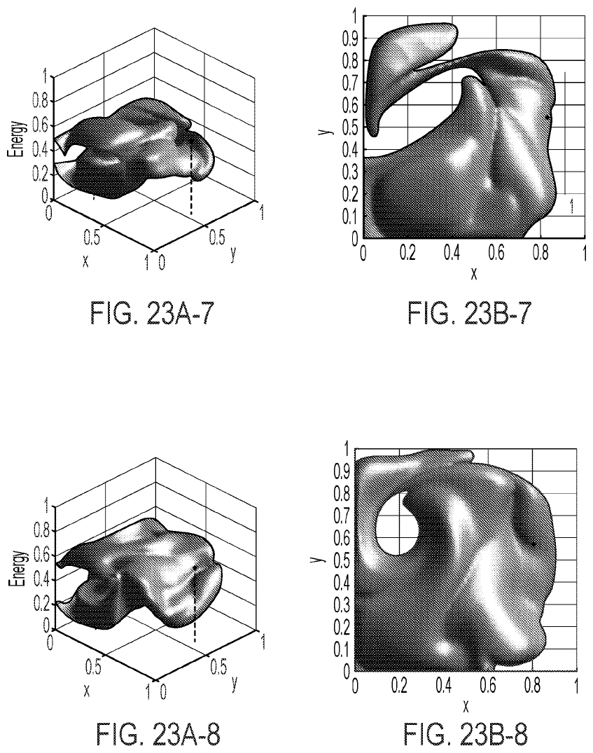

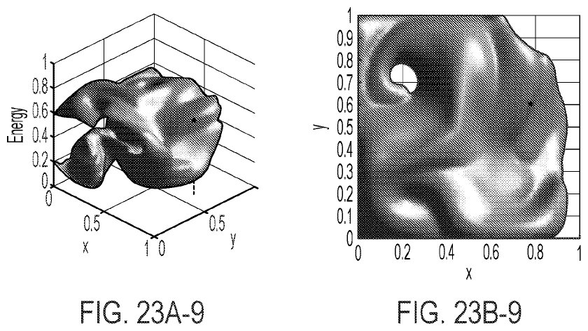

FIGS. 23A-1 through 23A-9 show a perspective view of and FIGS. 23B-1 through 23B-9 show a top-down view of the reachability front evolution for energy and time optimal path planning for the double gyre ocean circulation with target intercept case.

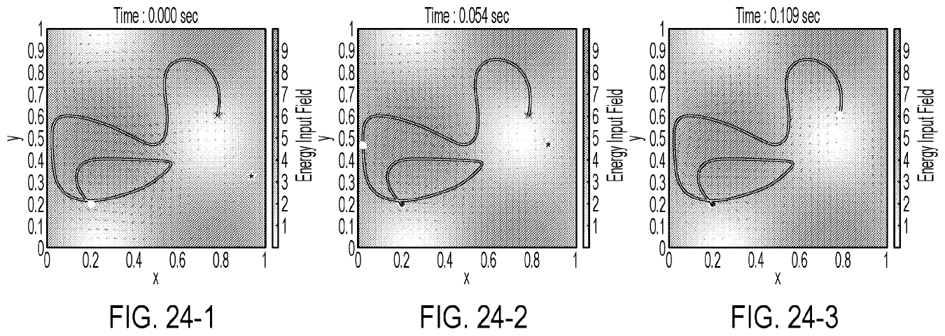

FIGS. 24-1 through 24-3 show a top-down view of the backtracked energy, constrained time optimal solution for energy and time optimal path planning for the double gyre ocean circulation with target intercept case.

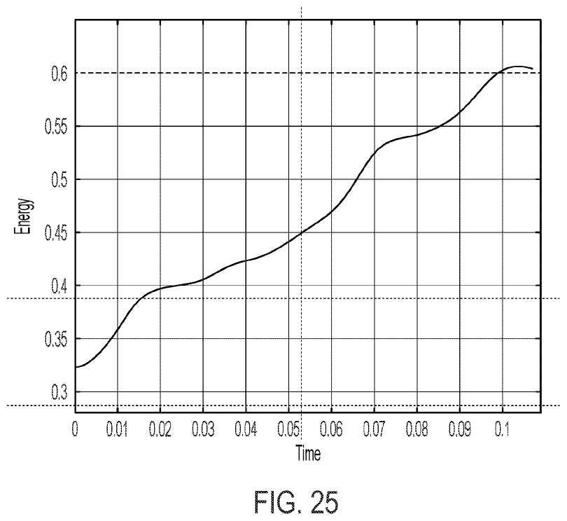

FIG. 25 shows required energy at target for the energy and time optimal path planning for the double gyre ocean circulation with target intercept case.

A fourth example relates to energy and time optimal path planning for a realistic ocean case. The energy and time optimal path planning methodologies described herein may also be applied to realistic settings. The following results provide path planning off the coast of Portugal using ocean forecasts computed by the MSEAS Primitive Equation solver. As in the previous example, for simplicity, the full Pareto front may not be traced out but instead, a path corresponding to a point on this front may be directly computed. Mission characteristics of this example are provided in Table I.

TABLE I

| Start | Offshore Funchai | |
|---|---|---|
| Speed | 1.4 | m/s |
| Energy Capacity | 2000 | Wh |
| Energy use rate coefficient | 8.2 | J sec²/m³ |
| Maximum charge rate | 29.2 | W |

| | |
|---|---|
| Starting battery level | 50% |
| Final required battery level | 10% |

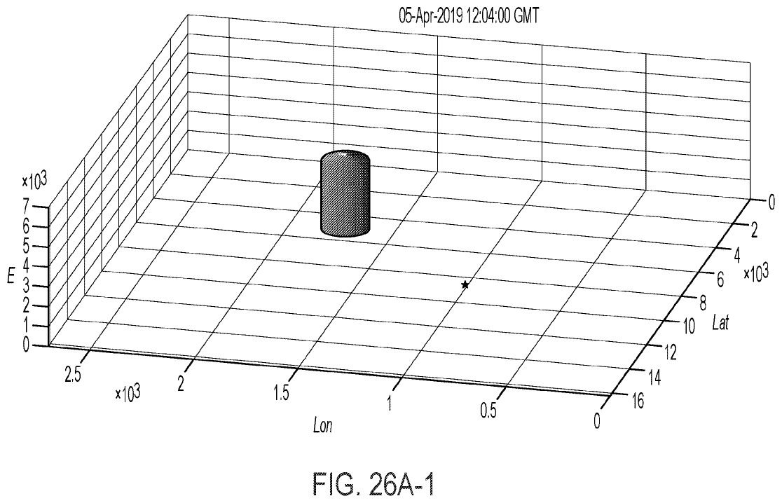

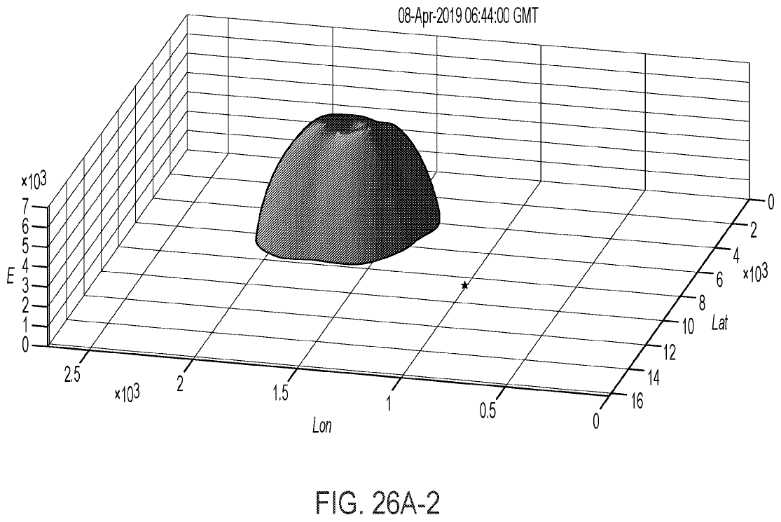

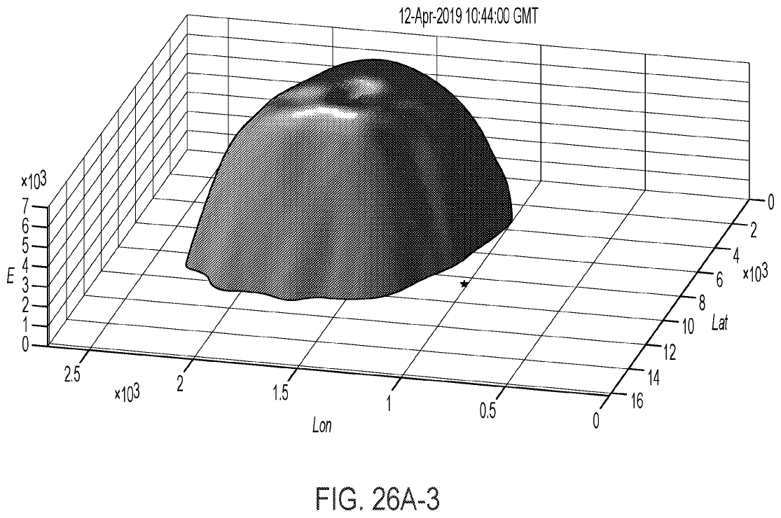

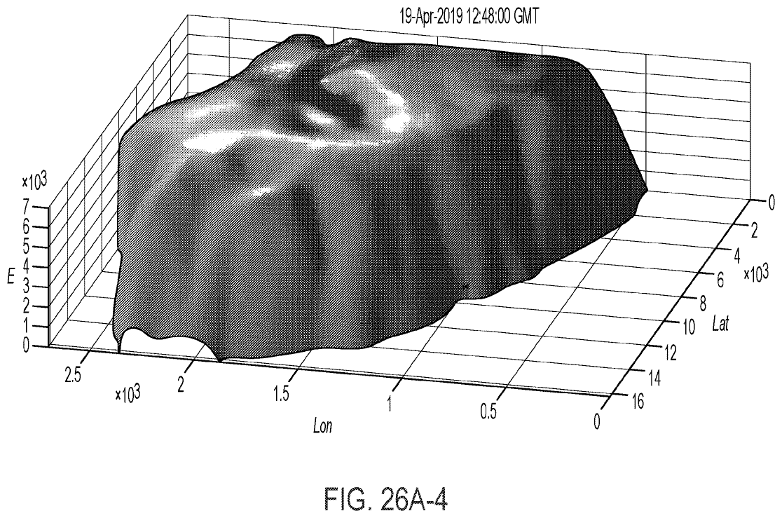

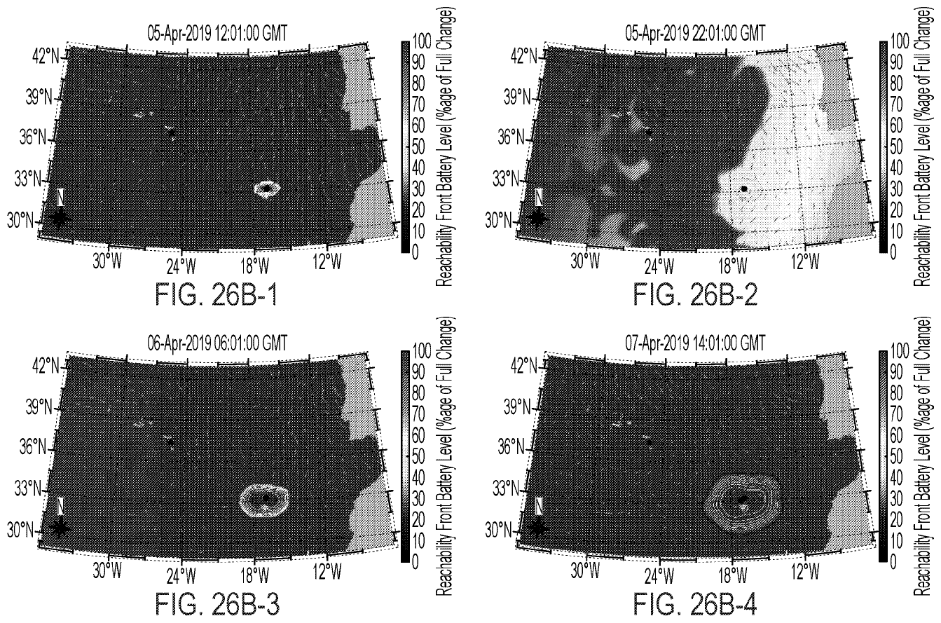

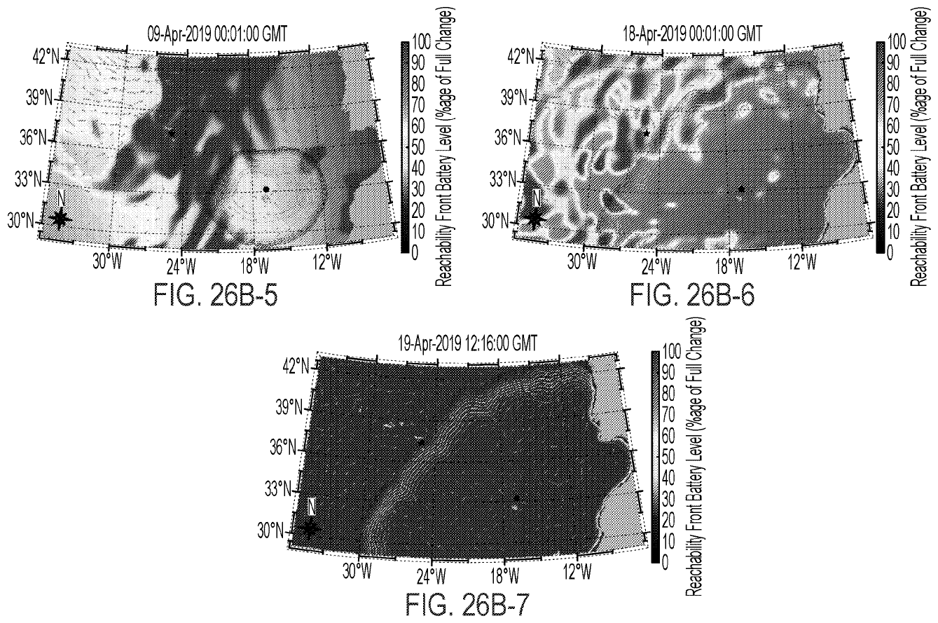

FIGS. 26A-1 through 26A-4 show a perspective view of and FIGS. 26B-1 through 26B-7 show a top-down view of the reachability front evolution for energy and time optimal path planning for the realistic ocean case.

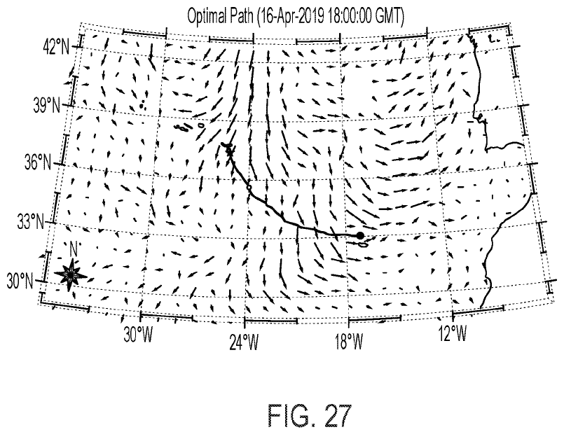

FIG. 27 shows a top-down view of optimal path for energy and time optimal path planning for the realistic ocean case.

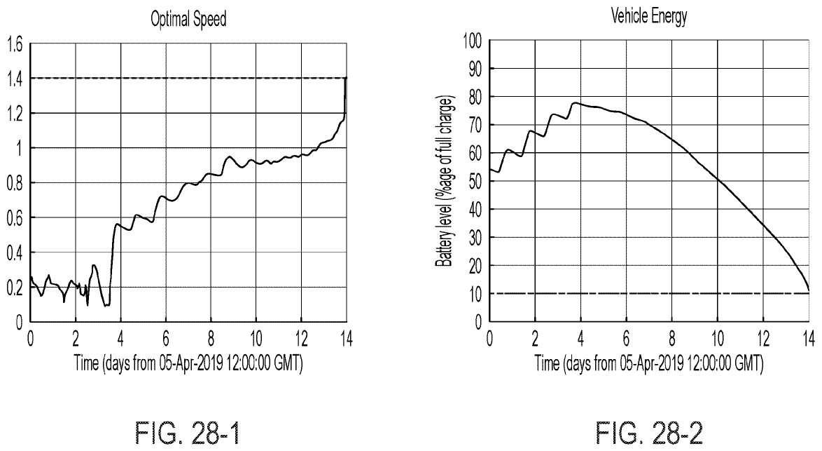

FIGS. 28-1 and 28-2 show optimal speed and vehicle energy for the energy and time optimal path planning for the realistic ocean case.

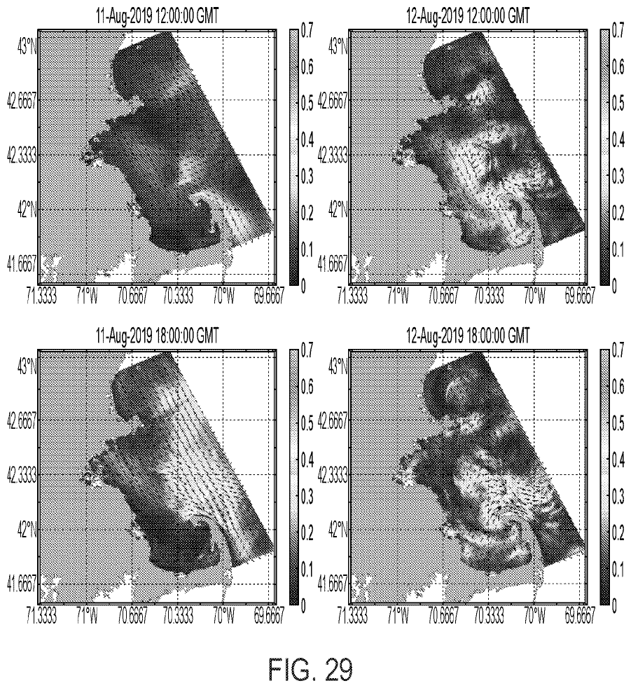

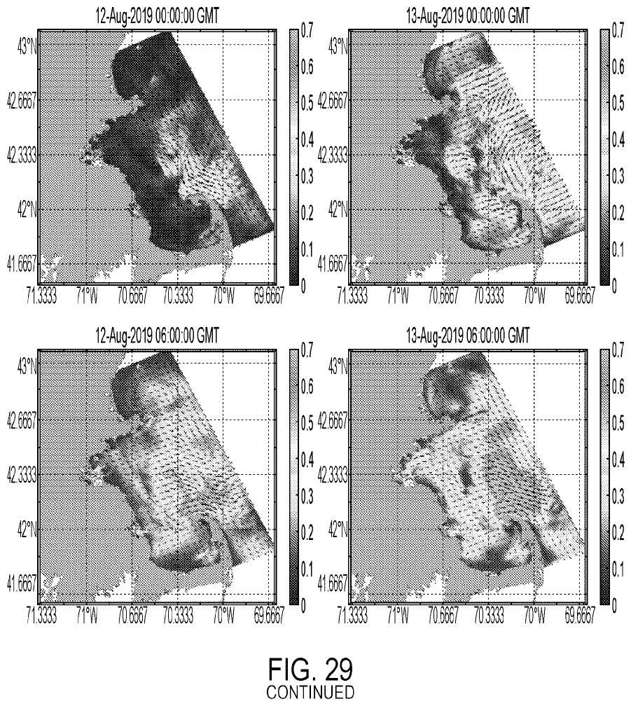

A fifth example relates to collecting dynamic chlorophyll fields. For example, for a more general case of collecting chlorophyll fields, the fields may be both advected by the flow and follow growth dynamics that depend on spatially varying fields like sunlight, nutrients, or other fields. To obtain the dynamics field, high-resolution coupled physical-biogeochemical MSEAS-PE simulations in the Massachusetts Bay region may be used, for example, as shown in FIG. 29. As in other examples, the task of the AUV is to go from the start point to the destination at a fixed speed while collecting the requisite amount of chlorophyll in the minimum time possible.

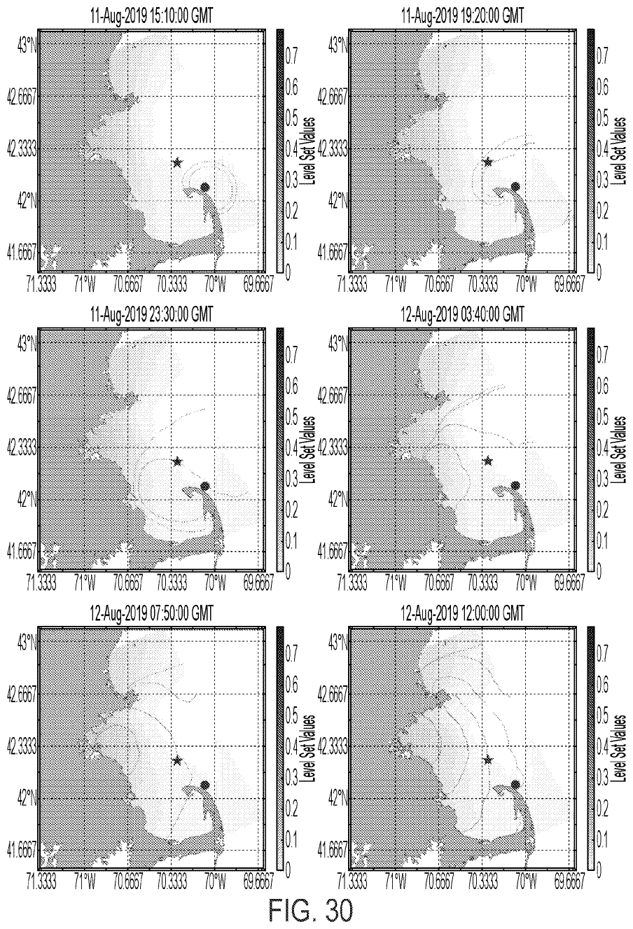

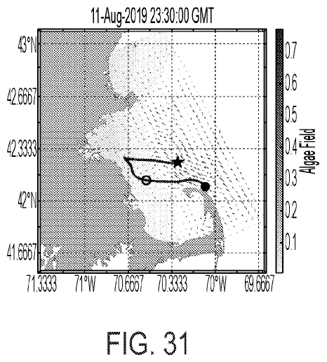

For the collecting dynamic chlorophyll fields example, FIG. 30 shows the evolution of the reachability front. The front expands as the regions the vehicle can reach in a given time increases. As the vehicle begins encountering higher CHL concentrations, the reachability front can move into higher regions in the collection space. The darker lines show the reachability front for a vehicle that has collected a higher amount of CHL in that much time. The forward solve ends when the reachability front hits the destination state. The methodology may then backtrack to compute the optimal path shown in FIG. 31.

A sixth example relates to optimal fish farming. The approach described herein may further be applied to concepts such as fully autonomous cages for farming fish, or autonomous moving fish farms. For optimal fish farming, the schemes described herein may be applied to compute paths that allow a vehicle to reach time optimally and maximize fish growth. Growth dynamics of fish is complex but can be simplified to depend on a field known as the Habitat Index, as shown in Equation 47.

$$\frac{d {M}_{t u n a , p}}{d t} = α \cdot {H}_{h a b} ( {X}_{p} ( t ) , t ) \qquad ( 47 )$$

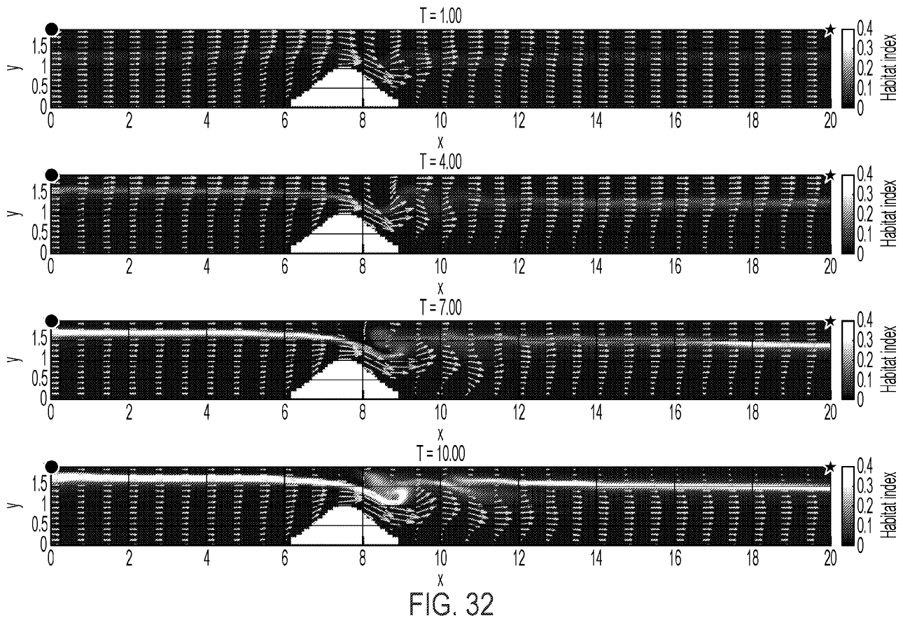

FIG. 32 shows the collection field for the example. FIG. 32 includes a seamount in environment creating an upwelling of nutrients. With the harvesting dynamics specified, the schemes described herein may be applied in an augmented state space (x, y, mₜᵤₙₐ). In this example, a fish farm moving in depth and range (for example, a 2D vertical slice) is considered. FIG.

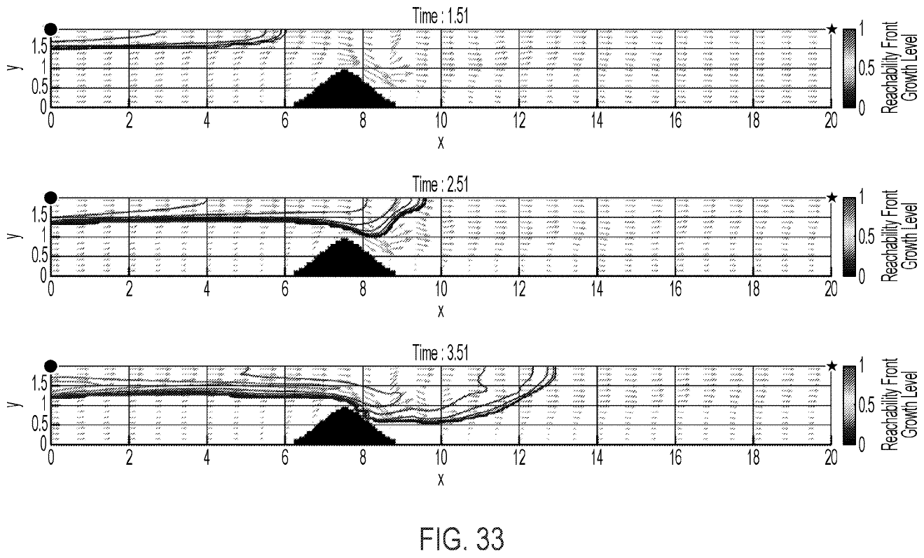

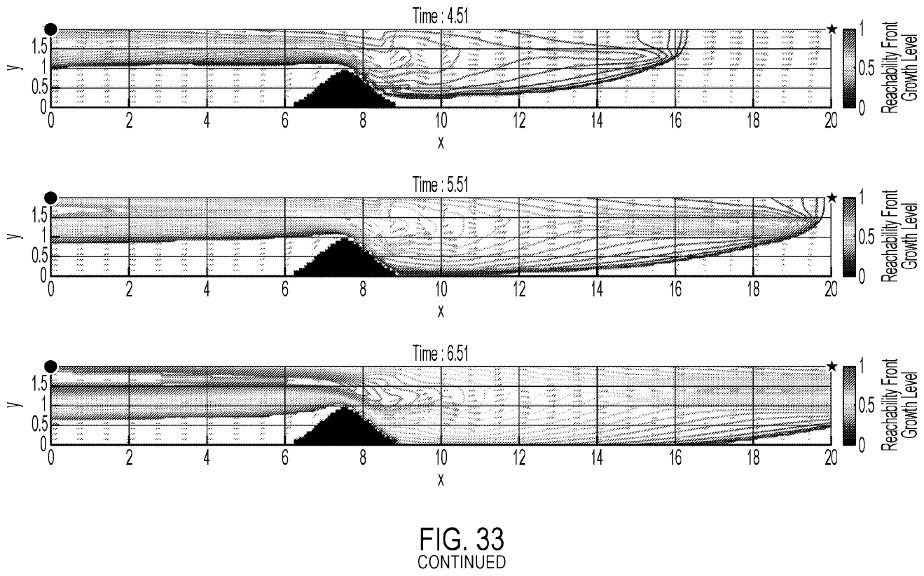

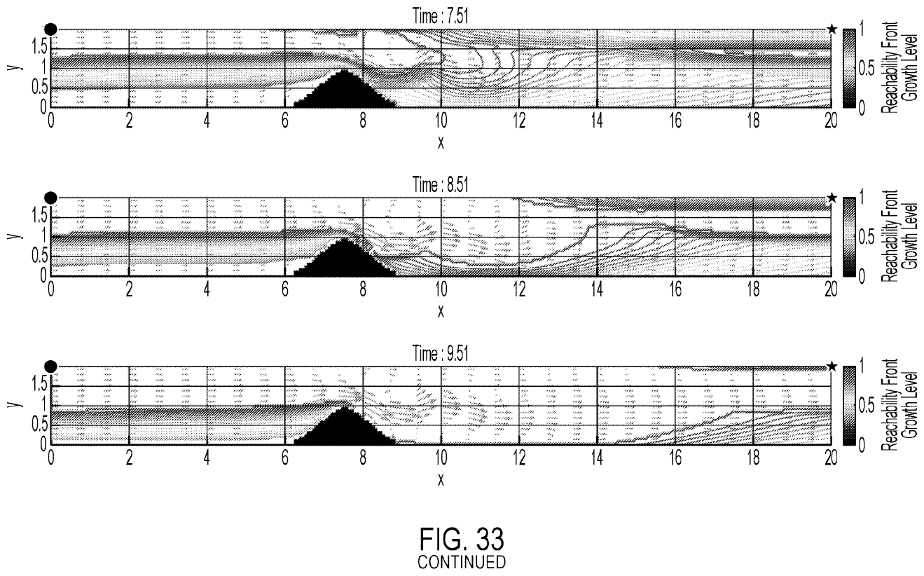

FIG. 33 shows a top-down view of the reachability front evolution for energy and time optimal path planning for the optimal fish farming case.

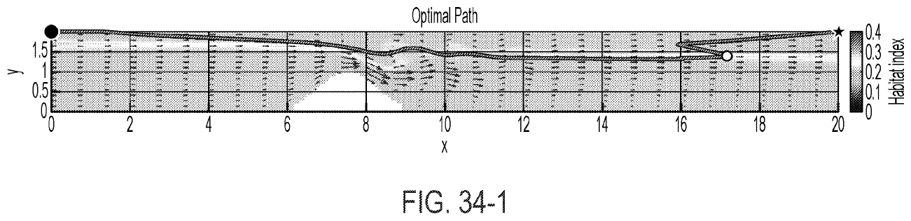

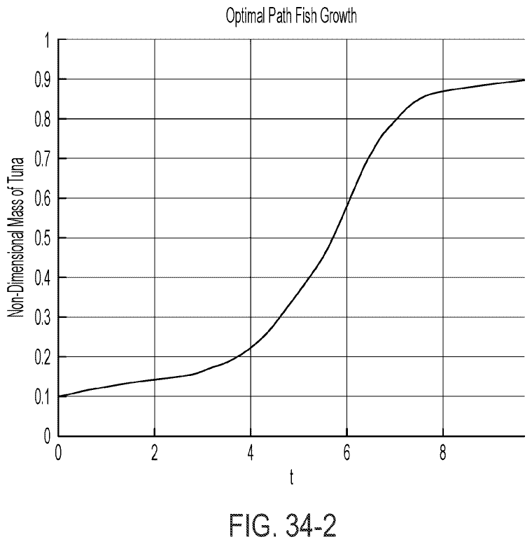

FIG. 34-1 shows a top-down view of optimal path for energy and time optimal path planning for the optimal fish farming case.

FIG. 34-2 show optimal path fish growth by mass of tuna for the energy and time optimal path planning for the optimal fish farming case.

Accordingly, the disclosure provides new theory and schemes for collection, usage, and time optimal path planning of ocean vehicles in dynamic flows. The collection and usage may be the optimal harvest and/or usage of any number of dynamic fields (for example, energy source, waste or pollution clean-up, food and culture harvest or sequestration, and/or any other transported material quantities.) Starting with equations for kinematics of the ocean vehicle and the collection physics, exact PDEs are provided that govern the augmented collection and physical-space forward reachable sets and tubes for multi-objective collection-time optimization in dynamic environments. Integrating the provided PDE and computing the feasibility set at the destination point provides the Pareto front through direct optimization. From the Pareto front, users can select all the one or more optimal solutions that they prefer based on their one or more collection and time trade-offs. The selected one or more solutions may then be backtracked to obtain the optimal one or more controls and optimal one or more paths to achieve the selected one or more solutions. According to some embodiments, the provided equations are exact and devoid of any heuristics, and the methodology is efficient. Explicit numerical schemes may be used to solve the forward PDE, and an implicit scheme may be used to solve the backtracking ODE.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (for example FIGS. 2-1 and 2-2) has been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method for use in automatically determining optimized routes for vehicles, the method comprising:
using at least one computer hardware processor to perform:
providing at least an initial location and at least a target final location of a vehicle, in physical space;
obtaining dynamic environmental flow field information and dynamic collectible field information;
determining, using the dynamic environmental flow field information and the dynamic collectible field information, at least one optimized route from the initial location to the target final location, comprising:
obtaining collection, usage, and time optimized reachable sets or tubes;
obtaining a Pareto front of Pareto solutions for optimum time and optimum collectible, reachable at the target final location; and
using the Pareto solutions to provide an optimized route for the vehicle;
guiding the vehicle using the optimized route; and
collecting an enhanced quantity of the collectible along the optimized route.

2. The method of claim 1, wherein:
obtaining the Pareto front of Pareto solutions for the optimum time and optimum collectible, reachable at the target final location, comprises numerically integrating multi-dimensional differential equations governing an augmented reachable set, and reachability front for multi-objective collection, usage, and time optimal path planning in dynamic environments to obtain the Pareto front of the Pareto solutions for time and the collectible by direct optimization on a reachable front projected on the target final location; and
using the Pareto solutions to provide an optimized route for the vehicle comprises numerically integrating, for the Pareto solutions, an augmented trajectory differential equation system backward in time, to provide the optimized route for the vehicle.

3. The method of claim 1, wherein the dynamic collectible field comprises an energy field.

4. The method of claim 1, wherein the dynamic collectible field comprises a waste or pollution field.

5. The method of claim 1, wherein the dynamic collectible field comprises a food or culture field.

6. The method of claim 1, wherein the dynamic collectible field comprises at least one field of a material or a quantity that is transported or affected by the dynamic environmental flow.

7. The method of claim 1, wherein guiding the vehicle using the optimized route comprises providing an optimal path and optimal controls to the vehicle.

8. The method of claim 6, wherein the vehicle comprises an autonomous vehicle.

9. At least one non-transitory computer-readable storage medium storing processor executable instructions that, when executed by at least one computer hardware processor, cause the at least one computer hardware processor to perform a method for use in automatically determining optimized routes for vehicles, the method comprising:
using at least one computer hardware processor to perform:
providing an initial location and a target final location of a vehicle, in physical space;
obtaining dynamic environmental flow field information and dynamic collectible field information;
determining, using the dynamic environmental flow field information and the dynamic collectible field information, at least one optimized route from the initial location to the target final location, comprising:
obtaining collection, usage, and time optimized reachable sets;
obtaining a Pareto front of Pareto solutions for optimum time and optimum collectible, reachable at the target final location; and
using the Pareto solutions to provide an optimized route for the vehicle;
guiding the vehicle using the optimized route; and
collecting an enhanced quantity of the collectible along the optimized route.

10. The at least one non-transitory computer-readable storage medium of claim 9, wherein:
obtaining the Pareto front of Pareto solutions for the optimum time and optimum collectible, reachable at the target final location, comprises numerically integrating multi-dimensional differential equations governing an augmented reachable set, and reachability front for multi-objective collection, usage, and time optimal path planning in dynamic environments to obtain the Pareto front of the Pareto solutions for time and the collectible by direct optimization on a reachable front projected on the target final location; and
using the Pareto solutions to provide an optimized route for the vehicle comprises numerically integrating, for the Pareto solutions, an augmented trajectory differential equation system backward in time, to provide the optimized route for the vehicle.

11. The at least one non-transitory computer-readable storage medium of claim 9, wherein the dynamic collectible field comprises an energy field.

12. The at least one non-transitory computer-readable storage medium of claim 9, wherein the dynamic collectible field comprises a waste or pollution field.

13. The at least one non-transitory computer-readable storage medium of claim 9, wherein the dynamic collectible field comprises a food or culture field.

14. The at least one non-transitory computer-readable storage medium of claim 9, wherein guiding the vehicle using the optimized route comprises providing an optimal path and optimal controls to vehicle.

15. The at least one non-transitory computer-readable storage medium of claim 14, wherein the vehicle comprises an autonomous vehicle.

16. A system, comprising:
at least one computer hardware processor;
at least one non-transitory computer-readable storage medium storing processor executable instructions that, when executed by the at least one computer hardware processor, cause the at least one computer hardware processor to perform a method for use in automatically determining an optimized route for a vehicle, the method comprising:
using at least one computer hardware processor to perform:
obtaining a target state, a fixed initial position of the vehicle, uncertain dynamic environmental flow information, and uncertain dynamic collectible field information; and
determining an optimized route from the fixed initial position to the target state using the uncertain dynamic environmental flow information and the uncertain dynamic collectible field information;
wherein the determining includes solving for stochastic collectible and time optimum paths and/or probabilistic reachability sets in a dynamically uncertain environment using dynamic stochastic order reduction including using a dynamically orthogonal (DO) decomposition of a stochastic time-optimal level set or value function to efficiently solve corresponding stochastic DO level-set equations; and
a device that guides the vehicle using the optimized route.

17. The system of claim 16, wherein determining the optimized route comprises calculating a forward reachability set and front by numerically solving an unsteady Hamilton-Jacobi (HJ) equation.

18. The system of claim 16, wherein the dynamic collectible field comprises an energy, waste, pollution, food, or culture field.

19-20. (canceled)

21. The system of claim 16, wherein the dynamic collectible field comprises at least one field of a material or a quantity that is transported or affected by the dynamic environmental flow.

22. The system of claim 16, wherein:
guiding the vehicle using the optimized route comprises providing an optimal path and optimal controls to vehicle; and
the vehicle comprises an autonomous vehicle.
